(19) United States
(12) Patent Application Publication
(10) Pub. No.: US 2025/0024468 A1
(43) Pub. Date: Jan. 16, 2025

(54) TERMINAL DEVICE, NETWORK NODE, AND METHODS THEREIN FOR SIDELINK SYNCHRONIZATION INFORMATION TRANSMISSION

(71) Applicant: Telefonaktiebolaget LM Ericsson (publ), Stockholm (SE)

(72) Inventors: Zhang Zhang, Beijing (CN); Min Wang, Luleå (SE)

(21) Appl. No.: 18/712,012

(22) PCT Filed: Nov. 24, 2022
(86) PCT No.: PCT/EP2022/083126

§ 371 Date: May 21, 2024

(30) Foreign Application Priority Data
Dec. 15, 2021 (WO) PCT/CN2021/138570

(51) Int. Cl. H04W 72/25; H04W 56/00; H04W 76/14

(52) U.S. Cl. CPC H04W 72/25; H04W 56/0015; H04W 76/14

(57) ABSTRACT

The present disclosure provides a method in a terminal device configured with a plurality of carrier frequencies for sidelink communication with a plurality of peer terminal devices. The method includes: transmitting, to each of the plurality of peer terminal devices, sidelink synchronization information on at least one carrier frequency for sidelink communication with the peer terminal device.

### TECHNICAL FIELD

The present disclosure relates to communication technology, and more particularly, to a terminal device, a network node, and methods therein for sidelink synchronization information transmission.

### BACKGROUND

Long Term Evolution (LTE) Device-to-Device (D2D) technology, also known as sidelink (SL) or PC5 interface, is specified by the 3^{rd} Generation Partnership Project (3GPP) as part of Release 12 (Rel-12). The target use cases were Proximity Services (communication and discovery). Support of sidelink was enhanced during Rel-13. In Rel-14, the LTE sidelink was extensively redesigned to support vehicular communications (commonly referred to as Vehicle-to-Everything (V2X) or Vehicle-to-Vehicle (V2V)). Support of sidelink was again enhanced during Rel-15. From the point of view of the lowest radio layers, the LTE sidelink uses broadcast communication. That is, transmission from a terminal device, or User Equipment (UE), targets any receiver that is in range.

In Rel-14 and Rel-15, LTE V2X related enhancements targeting the specific characteristics of vehicular communications were specified. In LTE V2X only broadcast is supported over sidelink.

In Rel-16, the 3GPP introduced sidelink for the 5th Generation (5G) New Radio (NR). The driving use cases were vehicular communications with more stringent requirements than those typically served using the LTE sidelink. To meet these requirements, the NR sidelink is capable of broadcast, groupcast, and unicast communications. In groupcast communication, intended receivers of a message are typically a subset of the vehicles near a transmitter, whereas in unicast communication, there is a single intended receiver.

Both the LTE sidelink and the NR sidelink can operate with or without network coverage and with varying degrees of interaction between UEs and a network, including support for standalone, network-less operations.

In Rel-17, the 3GPP is working on enhancements for the NR sidelink. The ambition is not only to improve the capabilities of NR sidelink for V2X but also to address other use cases such as National Security and Public Safety (NSPS) as well as commercial use cases such as Network Controlled Interactive Services (NCIS). In the future, the NR sidelink may be enhanced further to address other use cases too.

The 3GPP Radio Access Network (RAN) started discussions in RAN #84 to identify the detailed motivations and work areas for NR sidelink enhancements in Rel-17. Significant interest has been observed on enhanced reliability and reduced latency, which allows the support of Ultra Reliable Low Latency Communications (URLLC)-type sidelink use cases in wider operation scenarios. The system level reliability and latency performance of sidelink is affected by the communication conditions such as the wireless channel status and the offered load, and Rel-16 NR sidelink is expected to have limitation in achieving high reliability and low latency in some conditions, e.g., when the channel is relatively busy. Solutions that can enhance reliability and reduce latency are required in order to keep providing the use cases requiring low latency and high reliability under such communication conditions.

### SUMMARY

A UE capable of V2X sidelink communication and Sidelink Synchronization Signal (SLSS)/Physical Sidelink Broadcast Channel (PSBCH) transmission may transmit sidelink synchronization information (i.e., SLSS and sidelink Master Information Block (MIB)) on the frequency used for V2X sidelink communication when certain conditions are met, according to the 3GPP Technical Specification (TS) 36.331, V16.6.0, which is incorporated herein by reference in its entirety.

Rel-18 is currently under discussion in the 3GPP and sidelink Carrier Aggregation (CA) is considered as one of the first priority candidate topics for NR sidelink. With multiple sidelink carriers a natural issue is on which frequency or frequencies sidelink synchronization information should be transmitted.

It is an object of the present disclosure to provide a terminal device, a network node, and methods therein for sidelink synchronization information transmission.

According to a first aspect of the present disclosure, a method in a terminal device is provided. The terminal device is configured with a plurality of carrier frequencies for sidelink communication with a plurality of peer terminal devices. The method includes: transmitting, to each of the plurality of peer terminal devices, sidelink synchronization information on at least one carrier frequency for sidelink communication with the peer terminal device.

In an embodiment, for at least one of the plurality of peer terminal devices, the number of the at least one carrier frequency for sidelink communication with the peer terminal device may be less than the number of all carrier frequencies for sidelink communication with the peer terminal device.

In an embodiment, the sidelink synchronization information may be transmitted when:
the terminal device is not configured with a list of candidate synchronization carrier frequencies, or
the terminal device is configured with a list of candidate synchronization carrier frequencies and the list does not include any carrier frequency used for sidelink communication with the peer terminal device.

In an embodiment, among the plurality of carrier frequencies, a carrier frequency used for sidelink communication with more peer terminal devices may have a higher priority to be used for transmitting the sidelink synchronization information.

In an embodiment, for at least one of the plurality of peer terminal devices, the operation of transmitting, to each of the at least one peer terminal device, the sidelink synchronization information on at least one carrier frequency for sidelink communication with the peer terminal device may include: transmitting the sidelink synchronization information on a first number of, at least a second number of, or at most a third number of, carrier frequencies for sidelink communication with the peer terminal device.

In an embodiment, the first number, the second number, or the third number may be configured by a network node, and/or may be dependent on one or more of: the peer terminal device, a type of sidelink communication with the peer terminal device, a service type associated with sidelink communication with the peer terminal device, or a frequency band of the first, second, or third number of carrier frequencies.

In an embodiment, the type of sidelink communication may include broadcast, multicast, or unicast.

In an embodiment, for each carrier frequency used for sidelink communication with each peer terminal device, the sidelink synchronization information may be transmitted to the peer terminal device on the carrier frequency when:
the terminal device is not configured with a list of candidate synchronization carrier frequencies for the peer terminal device,
the terminal device is configured with a list of candidate synchronization carrier frequencies, but the list does not include any carrier frequency selected by the terminal device for sidelink communication with the peer terminal device, or the carrier frequency is selected as a synchronization carrier frequency, or
the terminal device is configured with a list of candidate synchronization carrier frequencies that includes the carrier frequency, and for the peer terminal device, the terminal device has selected another carrier frequency as a synchronization carrier frequency and the terminal device is capable of transmitting the sidelink synchronization information on the carrier frequency.

In an embodiment, for each peer terminal device, the sidelink synchronization information may be transmitted to the peer terminal device when:
the terminal device is in a Radio Resource Control (RRC) connected state and is configured by a network node to transmit the sidelink synchronization information to the peer terminal device,
the terminal device is in coverage and measured Uu Reference Signal Received Power (RSRP) is lower than a configured threshold for the peer terminal device,
the terminal device is out of coverage and selects a Global Navigation Satellite System (GNSS) as a synchronization reference source, or
the terminal device is out of coverage and not directly synchronized to the GNSS, and has no selected synchronization reference terminal device or has a selected synchronization reference terminal device but measured sidelink RSRP to the selected synchronization reference terminal device is lower than a preconfigured threshold for the peer terminal device.

According to a second aspect of the present disclosure, a method in a terminal device is provided. The terminal device is configured with one or more carrier frequencies for unicast sidelink communication with a peer terminal device. The method includes: determining whether and/or on which one or more carrier frequencies to transmit sidelink synchronization information to the peer terminal device based on assistance information; or receiving information on a determination, made based on the assistance information, about whether and/or on which one or more carrier frequencies to transmit the sidelink synchronization information to the peer terminal device. The assistance information includes one or more of: a list of carrier frequencies on which the peer terminal device is to monitor, is capable of monitoring, or prefers to monitor, sidelink synchronization information from the terminal device, or a synchronization reference resource selected by the peer terminal device.

In an embodiment, the operation of determining may include: determining not to transmit the sidelink synchronization information to the peer terminal device when the terminal device uses the same synchronization reference resource as selected by the peer terminal device, or the determination not to transmit the sidelink synchronization information to the peer terminal device may be made when the terminal device uses the same synchronization reference resource as selected by the peer terminal device.

In an embodiment, the method may further include, prior to the operation of determining: receiving the assistance information from the peer terminal device.

In an embodiment, the method may further include, prior to the operation of receiving: receiving the assistance information from the peer terminal device; and transmitting the assistance information to a network node. The information on the determination may be received from the network node.

In an embodiment, the information on the determination may be received from the peer terminal device.

In an embodiment, the information on the determination may be received from the peer terminal device using: RRC signaling, PC5 Signaling (PC5-S), Medium Access Control (MAC) Control Element (CE), control Protocol Data Unit (PDU) of a protocol layer, or Layer 1 (L1) signaling, or the information on the determination may be received from the network node using: RRC signaling, MAC CE, paging message, control PDU of a protocol layer, or L1 signaling.

According to a third aspect of the present disclosure, a method in a terminal device is provided. The method includes: transmitting sidelink synchronization information on one or more carrier frequencies when none of the one or more carrier frequencies is used for transmission of any sidelink traffic.

In an embodiment, the one or more carrier frequencies may include one or more carrier frequencies configured for legacy sidelink communication.

In an embodiment, the one or more carrier frequencies may include carrier frequencies specific to different releases or services.

According to a fourth aspect of the present disclosure, a method in a terminal device is provided. The method includes: receiving, from a peer terminal device configured with a plurality of carrier frequencies for sidelink communication, sidelink synchronization information on at least one carrier frequency for sidelink communication with the peer terminal device.

In an embodiment, the number of the at least one carrier frequency for sidelink communication with the peer terminal device may be less than the number of all carrier frequencies for sidelink communication with the peer terminal device.

In an embodiment, the sidelink synchronization information may be transmitted by the peer terminal device when:
the peer terminal device is not configured with a list of candidate synchronization carrier frequencies, or
the peer terminal device is configured with a list of candidate synchronization carrier frequencies and the list does not include any carrier frequency used for sidelink communication with the terminal device.

In an embodiment, among the plurality of carrier frequencies, a carrier frequency used for sidelink communication with more peer terminal devices may have a higher priority to be used by the peer terminal device for transmitting the sidelink synchronization information.

In an embodiment, the operation of receiving the sidelink synchronization information on at least one carrier frequency may include: receiving the sidelink synchronization information on a first number of, at least a second number of, or at most a third number of, carrier frequencies for sidelink communication with the peer terminal device.

In an embodiment, the first number, the second number, or the third number may be configured by a network node, and/or may be dependent on one or more of: the terminal device, a type of sidelink communication with the peer terminal device, a service type associated with sidelink communication with the peer terminal device, or a frequency band of the first, second, or third number of carrier frequencies.

In an embodiment, the type of sidelink communication may include broadcast, multicast, or unicast.

In an embodiment, for each carrier frequency used for sidelink communication with the peer terminal device, the sidelink synchronization information may be transmitted by the peer terminal device to the terminal device on the carrier frequency when:
the peer terminal device is not configured with a list of candidate synchronization carrier frequencies for the terminal device,
the peer terminal device is configured with a list of candidate synchronization carrier frequencies, but the list does not include any carrier frequency selected by the peer terminal device for sidelink communication with the terminal device, or the carrier frequency is selected as a synchronization carrier frequency, or
the peer terminal device is configured with a list of candidate synchronization carrier frequencies that includes the carrier frequency, and for the terminal device, the peer terminal device has selected another carrier frequency as a synchronization carrier frequency and the peer terminal device is capable of transmitting the sidelink synchronization information on the carrier frequency.

In an embodiment, the sidelink synchronization information may be transmitted by the peer terminal device to the terminal device when:
the peer terminal device is in an RRC connected state and is configured by a network node to transmit the sidelink synchronization information to the terminal device,
the peer terminal device is in coverage and measured Uu RSRP is lower than a configured threshold for the terminal device,
the peer terminal device is out of coverage and selects a GNSS as a synchronization reference source, or
the peer terminal device is out of coverage and not directly synchronized to the GNSS, and has no selected synchronization reference terminal device or has a selected synchronization reference terminal device but measured sidelink RSRP to the selected synchronization reference terminal device on the at least one carrier frequency is lower than a preconfigured threshold for the terminal device.

According to a fifth aspect of the present disclosure, a method in a terminal device is provided. The terminal device is configured for unicast sidelink communication with a peer terminal device. The method includes: transmitting, to the peer terminal device, assistance information; or transmitting, to the peer terminal device, information on a determination, made based on the assistance information, about whether and/or on which one or more carrier frequencies to transmit the sidelink synchronization information to the terminal device. The assistance information may include one or more of: a list of carrier frequencies on which the terminal device is to monitor, is capable of monitoring, or prefers to monitor, sidelink synchronization information from the peer terminal device, or a synchronization reference resource selected by the terminal device.

In an embodiment, no sidelink synchronization information from the peer terminal device may be expected when the terminal device uses the same synchronization reference resource as selected by the terminal device, or the determination not to transmit the sidelink synchronization information to the terminal device may be made when the peer terminal device uses the same synchronization reference resource as selected by the terminal device.

In an embodiment, the method may further include, prior to transmitting the information on the determination: transmitting the assistance information to a network node; and receiving the information on the determination from the network node.

In an embodiment, the assistance information or the information on the determination may be transmitted to the peer terminal device using: RRC signaling, PC5-S, MAC CE, control PDU of a protocol layer, or L1 signaling.

According to a sixth aspect of the present disclosure, a method in a terminal device is provided. The method includes: receiving sidelink synchronization information on one or more carrier frequencies when none of the one or more carrier frequencies is used for transmission of any sidelink traffic.

In an embodiment, the one or more carrier frequencies may include one or more carrier frequencies configured for legacy sidelink communication.

In an embodiment, the one or more carrier frequencies may include carrier frequencies specific to different releases or services.

According to a seventh aspect of the present disclosure, a method in a network node is provided. The method includes: determining, for a terminal device configured with a plurality of carrier frequencies for sidelink communication with a plurality of peer terminal devices, a configuration to transmit, to each of the plurality of peer terminal devices, sidelink synchronization information on at least one carrier frequency for sidelink communication with the peer terminal device; and signaling the configuration to the terminal device.

In an embodiment, the configuration may configure, for at least one of the plurality of peer terminal devices, the terminal device to transmit the sidelink synchronization information on a first number of, at least a second number of, or at most a third number of, carrier frequencies for sidelink communication with the peer terminal device.

In an embodiment, the first number, the second number, or the third number may be dependent on one or more of: the peer terminal device, a type of sidelink communication with the peer terminal device, a service type associated with sidelink communication with the peer terminal device, or a frequency band of the first, second, or third number of carrier frequencies.

In an embodiment, the method may further include: signaling, to the terminal device, a list of candidate synchronization carrier frequencies for each of at least one of the plurality of peer terminal devices.

In an embodiment, the method may further include, for each peer terminal device: signaling, to the terminal device, a threshold of measured Uu RSRP for the peer terminal device; or signaling, to the terminal device, a threshold of measured sidelink RSRP to a selected synchronization reference terminal device for the peer terminal device.

According to an eighth aspect of the present disclosure, a method in a network node is provided. The method includes: receiving assistance information; and determining whether and/or on which one or more carrier frequencies a terminal device is to transmit sidelink synchronization information to a peer terminal device based on assistance information. The assistance information may include one or more of: a list of carrier frequencies on which the peer terminal device is to monitor, is capable of monitoring, or prefers to monitor, sidelink synchronization information from the terminal device, or a synchronization reference resource selected by the peer terminal device.

In an embodiment, the operation of determining may include: determining that the terminal device is not to transmit the sidelink synchronization information to the peer terminal device when the terminal device uses the same synchronization reference resource as selected by the peer terminal device.

In an embodiment, the network node may be a serving network node of the terminal device and the assistance information may be received from the terminal device. The method may further include: transmitting, to the terminal device, information on whether and/or on which one or more carrier frequencies the terminal device is to transmit the sidelink synchronization information to the peer terminal device.

In an embodiment, the network node may be a serving network node of the peer terminal device and the assistance information may be received from the peer terminal device. The method may further include: transmitting, to the peer terminal device or a serving network node of the terminal device, information on whether and/or on which one or more carrier frequencies the terminal device is to transmit the sidelink synchronization information to the peer terminal device.

In an embodiment, the assistance information may be received using: RRC signaling, MAC CE, paging message, control PDU of a protocol layer, or L1 signaling.

According to a ninth aspect of the present disclosure, a method in a network node is provided. The method includes: determining, for a terminal device, a configuration to transmit sidelink synchronization information on one or more carrier frequencies when none of the one or more carrier frequencies is used by the terminal device for transmission of any sidelink traffic; and signaling the configuration to the terminal device.

In an embodiment, the one or more carrier frequencies may include one or more carrier frequencies configured for legacy sidelink communication.

In an embodiment, the one or more carrier frequencies may include carrier frequencies specific to different releases or services.

According to a tenth aspect of the present disclosure, a terminal device is provided. The terminal device includes a transceiver, a processor and a memory. The memory contains instructions executable by the processor whereby the terminal device is operative to perform the method according to any of the above first to sixth aspects.

According to an eleventh aspect of the present disclosure, a computer readable storage medium is provided. The computer readable storage medium has computer program instructions stored thereon. The computer program instructions, when executed by a processor in a terminal device, cause the terminal device to perform the method according to any of the above first to sixth aspects.

According to a twelfth aspect of the present disclosure, a network node is provided. The network node includes a transceiver, a processor and a memory. The memory contains instructions executable by the processor whereby the network node is operative to perform the method according to any of the above seventh to ninth aspect.

According to a thirteenth aspect of the present disclosure, a computer readable storage medium is provided. The computer readable storage medium has computer program instructions stored thereon. The computer program instructions, when executed by a processor in a network node, cause the network node to perform the method according to any of the above seventh to ninth aspect.

With some embodiments of the present disclosure, a terminal device configured with a plurality of carrier frequencies for sidelink communication with a plurality of peer terminal devices can transmit, to each of the plurality of peer terminal devices, sidelink synchronization information on at least one carrier frequency for sidelink communication with the peer terminal device. In this way, it can be ensured that each peer terminal device can receive the sidelink synchronization information on at least one carrier frequency for sidelink communication.

### BRIEF DESCRIPTION OF THE DRAWINGS

The above and other objects, features and advantages will be more apparent from the following description of embodiments with reference to the figures, in which:

FIG. 1 is a flowchart illustrating a method in a terminal device according to an embodiment of the present disclosure;

FIG. 2 is a flowchart illustrating a method in a terminal device according to another embodiment of the present disclosure;

FIG. 3 is a flowchart illustrating a method in a terminal device according to another embodiment of the present disclosure;

FIG. 4 is a flowchart illustrating a method in a terminal device according to another embodiment of the present disclosure;

FIG. 5 is a flowchart illustrating a method in a terminal device according to another embodiment of the present disclosure;

FIG. 6 is a flowchart illustrating a method in a terminal device according to another embodiment of the present disclosure;

FIG. 7 is a flowchart illustrating a method in a network node according to an embodiment of the present disclosure;

FIG. 8 is a flowchart illustrating a method in a network node according to another embodiment of the present disclosure;

FIG. 9 is a flowchart illustrating a method in a network node according to another embodiment of the present disclosure;

FIG. 10 is a block diagram of a terminal device according to an embodiment of the present disclosure;

FIG. 11 is a block diagram of a terminal device according to another embodiment of the present disclosure;

FIG. 12 is a block diagram of a network node according to an embodiment of the present disclosure;

FIG. 13 is a block diagram of a network node according to another embodiment of the present disclosure;

FIG. 14 schematically illustrates a telecommunication network connected via an intermediate network to a host computer;

FIG. 15 is a generalized block diagram of a host computer communicating via a base station with a user equipment over a partially wireless connection; and

FIGS. 16 to 19 are flowcharts illustrating methods implemented in a communication system including a host computer, a base station and a user equipment.

### DETAILED DESCRIPTION

As used herein, the term “wireless communication network” refers to a network following any suitable communication standards, such as NR, LTE-Advanced (LTE-A), LTE, Wideband Code Division Multiple Access (WCDMA), High-Speed Packet Access (HSPA), and so on. Furthermore, the communications between a terminal device and a network node in the wireless communication network may be performed according to any suitable generation communication protocols, including, but not limited to, Global System for Mobile Communications (GSM), Universal Mobile Telecommunications System (UMTS), Long Term Evolution (LTE), and/or other suitable 1G (the first generation), 2G (the second generation), 2.5G, 2.75G, 3G (the third generation), 4G (the fourth generation), 4.5G, 5G (the fifth generation) communication protocols, wireless local area network (WLAN) standards, such as the IEEE 802.11 standards; and/or any other appropriate wireless communication standard, such as the Worldwide Interoperability for Microwave Access (WiMax), Bluetooth, and/or ZigBee standards, and/or any other protocols either currently known or to be developed in the future.

The term “network node” or “network device” refers to a device in a wireless communication network via which a terminal device accesses the network and receives services therefrom. The network node or network device refers to a base station (BS), an access point (AP), or any other suitable device in the wireless communication network. The BS may be, for example, a node B (NodeB or NB), an evolved NodeB (eNodeB or eNB), or a (next) generation NodeB (gNB), a Remote Radio Unit (RRU), a radio header (RH), a remote radio head (RRH), a relay, a low power node such as a femto, a pico, and so forth. Yet further examples of the network node may include multi-standard radio (MSR) radio equipment such as MSR BSs, network controllers such as radio network controllers (RNCs) or base station controllers (BSCs), base transceiver stations (BTSs), transmission points, transmission nodes. More generally, however, the network node may represent any suitable device (or group of devices) capable, configured, arranged, and/or operable to enable and/or provide a terminal device access to the wireless communication network or to provide some service to a terminal device that has accessed the wireless communication network.

The term “terminal device” refers to any end device that can access a wireless communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, portable computers, desktop computers, image capture terminal devices such as digital cameras, gaming terminal devices, music storage and playback appliances, a mobile phone, a cellular phone, a smart phone, voice over IP (VOIP) phones, wireless local loop phones, tablets, personal digital assistants (PDAs), wearable terminal devices, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3rd Generation Partnership Project (3GPP), such as 3GPP's GSM, UMTS, LTE, and/or 5G standards. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the wireless communication network. Instead, a UE may represent a device that is intended for sale to, or operation by, a human user but that may not initially be associated with a specific human user.

The terminal device may support device-to-device (D2D) communication, for example by implementing a 3GPP standard for sidelink communication, and may in this case be referred to as a D2D communication device.

As yet another example, in an Internet of Things (IOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

As used herein, a downlink transmission refers to a transmission from the network node to a terminal device, and an uplink transmission refers to a transmission in an opposite direction.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms. The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

According to the 3GPP TS 36.331, a UE may transmit sidelink synchronization information (i.e., SLSS and sidelink MIB) on a frequency used for sidelink communication when the following conditions are met:

### Condition 1:

a list of candidate synchronization carrier frequencies (syncFreqList) are not (pre)configured, or
the list (syncFreqList) is (pre)configured, but it does not include any frequency selected by the UE for its sidelink transmission, or the concerned frequency is selected as the synchronization carrier frequency,
the list (syncFreqList) is (pre)configured and includes the concerned frequency, and the UE has selected a frequency other than the concerned frequency as the synchronization carrier frequency, and the UE is able to transmit SLSS/PSBCH on the concerned frequency.

### Condition 2:

the UE is in RRC connected, and configured by the network that synchronization information shall be transmitted, or
the UE is in coverage, and the measured Uu RSRP is lower than a configured threshold, or
the UE is out of coverage, and selects GNSS as the synchronization reference source, or
the UE is out of coverage and not directly synchronized to GNSS, and has no selected synchronization reference (SyncRef) UE or the measured SL-RSRP to the selected SyncRef UE is below a preconfigured threshold.

In the case of limited transmission capabilities on multiple carrier frequencies, when the UE is configured with syncFreqList, whether to transmit SLSS/PSBCH on a frequency selected for sidelink transmission other than the synchronization carrier frequency, is up to UE implementation.

However, it may be problematic if the above mechanism is directly reused for sidelink CA in NR. For example, when a UE transmits to multiple destinations or peer UEs over sidelink and different sidelink carriers are configured/selected for transmission towards different peer UEs, if syncFreqList only includes carriers configured/selected for transmission towards some of the peer UEs, no sidelink synchronization information will be transmitted in the configured/selected carriers for transmission towards other peer UEs that do not overlap with carriers included in syncFreqList. Thus, these peer UEs associated only with carriers not included in syncFreqList may not be able to receive sidelink transmissions from the UE due to lack of sidelink synchronization information from the UE. In addition, when syncFreqList is not (pre)configured or it is (pre)configured but does not include any frequency selected by the UE for its sidelink transmission, the UE will transmit sidelink synchronization information on all frequencies used for sidelink transmission, which is inefficient and power-consuming. Moreover, NR supports unicast so UEs can exchange signaling over sidelink, it may thus not be optimal to apply the above mechanism designed only for broadcast.

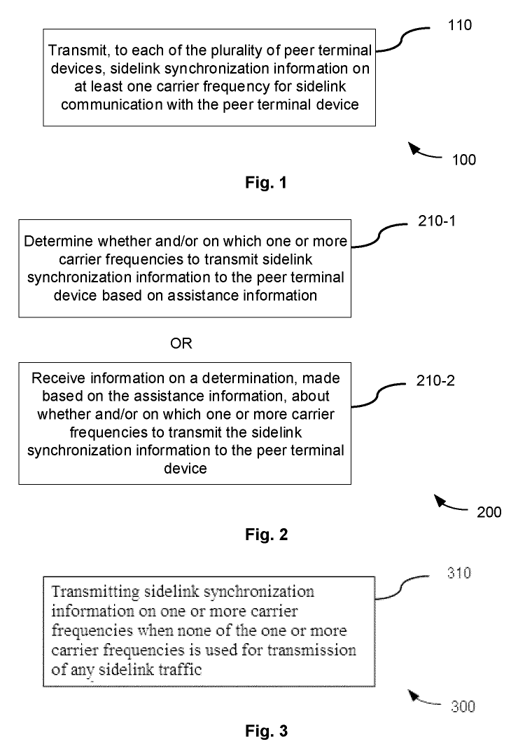

FIG. 1 is a flowchart illustrating a method 100 according to an embodiment of the present disclosure. The method 100 may be performed at a terminal device, e.g., a transmitting (Tx) UE in the sense that it is to transmit sidelink synchronization information. The terminal device is configured with a plurality of carrier frequencies for sidelink communication with a plurality of peer terminal devices (destinations, or receiving (Rx) UEs in the sense that they are to receive sidelink synchronization information). Each peer terminal device may be represented by a Layer 2 Destination Identifier (L2 DST ID).

At block 110, the terminal device transmits, to each of the plurality of peer terminal devices, sidelink synchronization information on at least one carrier frequency for sidelink communication with the peer terminal device, e.g., when the terminal device is not configured with a list of candidate synchronization carrier frequencies, or when the terminal device is configured with a list of candidate synchronization carrier frequencies and the list does not include any carrier frequency used for sidelink communication with the peer terminal device.

In an example, for at least one of the plurality of peer terminal devices, the number of the at least one carrier frequency for sidelink communication with the peer terminal device may be less than the number of all carrier frequencies for sidelink communication with the peer terminal device, so as to save power e.g., when the terminal device is not configured with a list of candidate synchronization carrier frequencies.

In an example, the terminal device may transmit the sidelink synchronization information to a peer terminal device on a carrier frequency only when Condition 2 as described above is met for that carrier frequency. If there is no such carrier frequency for a peer terminal device, the terminal device may not transmit sidelink synchronization information the peer terminal device.

In an example, among the plurality of carrier frequencies, a carrier frequency used for sidelink communication with more peer terminal devices may have a higher priority to be used for transmitting the sidelink synchronization information. In other words, the Tx UE may prioritize transmitting the sidelink synchronization information on the frequency shared by more Rx UEs. For example, assuming that the Tx UE uses carrier frequencies f1, f2, and f3 for sidelink communication with Rx UE 1, carrier frequencies f2, f3, and f4 for sidelink communication with Rx UE 2, and carrier frequencies f3, f4, and f5 for sidelink communication with Rx UE 4, the Tx UE may prioritize transmitting the sidelink synchronization information on the carrier frequency f3 as it is shared by all the 3 Rx UEs.

In an example, for at least one of the plurality of peer terminal devices, in the block 110, the sidelink synchronization information may be transmitted on a first number of, at least a second number of, or at most a third number of, carrier frequencies for sidelink communication with the peer terminal device. Here, the first number, the second number, or the third number may be configured by a network node (e.g., a serving gNB of the terminal device), and/or may be dependent on one or more of: the peer terminal device, a type (e.g., broadcast, multicast, or unicast) of sidelink communication with the peer terminal device, a service type associated with sidelink communication with the peer terminal device, or a frequency band of the first, second, or third number of carrier frequencies. For example, the sidelink synchronization information may be transmitted on more carrier frequencies when the carrier frequencies are in a relatively high frequency band (e.g., Frequency Range 2 (FR2)), and vice versa. For example, assuming that the sidelink synchronization information is to be transmitted to an Rx UE on at most m carrier frequencies, and that the Tx UE can transmit the sidelink synchronization information on n carrier frequencies (e.g. according to Condition 2 as described above), the UE may transmit the sidelink synchronization information on x carrier frequencies out of the n carrier frequencies, where x is a number in the range between 1 and min(m, n). In another example, assuming that the sidelink synchronization information is to be transmitted to an Rx UE on at least m carrier frequencies, the UE may transmit the sidelink synchronization information in y carrier frequencies out of the n carrier frequencies, where y is a number in the range between min(m, n) and n.

In an example, Condition 1 as described above may be checked per peer terminal device. In particular, for each carrier frequency used for sidelink communication with each peer terminal device, the sidelink synchronization information may be transmitted to the peer terminal device on the carrier frequency (or Condition 1 is regarded as met) when:
the terminal device is not configured with a list of candidate synchronization carrier frequencies for the peer terminal device,
the terminal device is configured with a list of candidate synchronization carrier frequencies, but the list does not include any carrier frequency selected by the terminal device for sidelink communication with the peer terminal device, or the carrier frequency is selected as a synchronization carrier frequency, or
the terminal device is configured with a list of candidate synchronization carrier frequencies that includes the carrier frequency, and for the peer terminal device, the terminal device has selected another carrier frequency as a synchronization carrier frequency and the terminal device is capable of transmitting the sidelink synchronization information on the carrier frequency.

In addition, Condition 2 as described above may be checked per peer terminal device (or per type of peer terminal device). In particular, for each peer terminal device or type of peer terminal device, the sidelink synchronization information may be transmitted to the peer terminal device or type of peer terminal device (or Condition 2 is regarded as met) when:
the terminal device is in an RRC connected state and is configured by a network node to transmit the sidelink synchronization information to the peer terminal device or type of peer terminal device,
the terminal device is in coverage and measured Uu RSRP is lower than a configured threshold for the peer terminal device or type of peer terminal device,
the terminal device is out of coverage and selects a GNSS as a synchronization reference source, or
the terminal device is out of coverage and not directly synchronized to the GNSS, and has no selected synchronization reference terminal device or has a selected synchronization reference terminal device but measured sidelink RSRP to the selected synchronization reference terminal device is lower than a preconfigured threshold for the peer terminal device or type of peer terminal device.

That is, the Tx UE may transmit the sidelink synchronization information to an Rx UE on a carrier frequency when Condition 1 is met for the Rx UE and Condition 2 is met for the Rx UE or type of Rx UE.

FIG. 2 is a flowchart illustrating a method 200 according to an embodiment of the present disclosure. The method 200 may be performed at a terminal device, e.g., a Tx UE in the sense that it is to transmit sidelink synchronization information. The terminal device is configured with one or more carrier frequencies for unicast sidelink communication with a peer terminal device (destination, or Rx UE in the sense that it is to receive sidelink synchronization information).

At block 210-1, the terminal device determines whether and/or on which one or more carrier frequencies to transmit sidelink synchronization information to the peer terminal device based on assistance information. The assistance information may include one or more of: a list of carrier frequencies on which the peer terminal device is to monitor, is capable of monitoring, or prefers to monitor, sidelink synchronization information from the terminal device, or a synchronization reference resource (e.g., GNSS or network node) selected by the peer terminal device.

In an example, before the block 210-1, the terminal device may receive the assistance information from the peer terminal device.

In an example, in the block 210-1, the terminal device may determine not to transmit the sidelink synchronization information to the peer terminal device when the terminal device uses the same synchronization reference resource as selected by the peer terminal device, e.g., even if Condition 1 and Condition 2 as described above are met. For example, the terminal device may receive from a network node (e.g., a serving gNB) a configuration not to transmit the sidelink synchronization information to the peer terminal device when the terminal device uses the same synchronization reference resource as selected by the peer terminal device.

In an example, in the block 210-1, the terminal device may determine to transmit the sidelink synchronization information to the peer terminal device, e.g., when Condition 1 and Condition 2 as described above are met, and determine on which one or more carrier frequencies to transmit sidelink synchronization information to the peer terminal device based at least in part on the list of carrier frequencies on which the peer terminal device is to monitor, is capable of monitoring, or prefers to monitor, the sidelink synchronization information from the terminal device.

Alternatively, at block 210-2, the terminal device receives information on a determination, made based on the assistance information, about whether and/or on which one or more carrier frequencies to transmit the sidelink synchronization information to the peer terminal device.

For example, the terminal device may receive the assistance information from the peer terminal device, transmit the assistance information to a network node (e.g., a serving gNB), for example, when the terminal device is in RRC connected, and then in the block 210-2 receive the information on the determination from the network node. Alternatively, in the block 210-2, the terminal device may receive the information on the determination from the peer terminal device.

In an example, the determination not to transmit the sidelink synchronization information to the peer terminal device may be made when the terminal device uses the same synchronization reference resource as selected by the peer terminal device.

It will be appreciated that the embodiment(s) of the method 200 may be implemented individually or in combination with (or on the basis of) the embodiment(s) or applicable features of the method 100 as described above.

Further, all the embodiments described in the disclosure are intended to be illustrative in all respects, rather than restrictive, of the embodiments. Thus the embodiments are capable of many variations in detailed implementation that can be derived from the description contained herein by a person skilled in the art.

FIG. 3 is a flowchart illustrating a method 300 according to an embodiment of the present disclosure. The method 300 may be performed at a terminal device, e.g., a Tx UE in the sense that it is to transmit sidelink synchronization information to a peer terminal device (destination, or Rx UE in the sense that it is to receive sidelink synchronization information).

At block 310, the terminal device transmits sidelink synchronization information on one or more carrier frequencies when none of the one or more carrier frequencies is used for transmission of any sidelink traffic.

In an example, the one or more carrier frequencies may be one or more carrier frequencies configured for legacy (e.g., Rel-16) sidelink communication. Alternatively, the one or more carrier frequencies may include carrier frequencies specific to different releases or services.

For example, the Tx UE may be (pre)configured that SLSS/PSBCH is always (and only) transmitted on specific (pre)configured frequencies, even the UE is not transmitting any traffic on the frequencies, e.g., frequencies where Rel-16 sidelink communication is performed, such that the transmitted SLSS/PSBCH can be received by all NR UEs capable of sidelink communication regardless of the release(s) they support. Alternatively, for different releases, different specific frequencies may be (pre)configured for transmitting SLSS/PSBCH. In one example, discovery and/or unicast link establishment may only be transmitted on frequencies where SLSS/PSBCH is transmitted. In another example, each service may be (pre)configured with specific frequencies where SLSS/PSBCH is transmitted, and a UE transmitting or interested in receiving the service shall be capable of transmitting or receiving SLSS/PSBCH on these specific frequencies.

FIG. 4 is a flowchart illustrating a method 400 according to an embodiment of the present disclosure. The method 400 may be performed at a terminal device, e.g., an Rx UE in the sense that it is to receive sidelink synchronization information from a peer terminal device (Tx UE in the sense that it is to transmit sidelink synchronization information).

At block 410, the terminal device receives, from a peer terminal device configured with a plurality of carrier frequencies for sidelink communication, sidelink synchronization information on at least one carrier frequency for sidelink communication with the peer terminal device.

In an example, the number of the at least one carrier frequency for sidelink communication with the peer terminal device may be less than the number of all carrier frequencies for sidelink communication with the peer terminal device.

In an example, the sidelink synchronization information may be transmitted by the peer terminal device when: the peer terminal device is not configured with a list of candidate synchronization carrier frequencies, or the peer terminal device is configured with a list of candidate synchronization carrier frequencies and the list does not include any carrier frequency used for sidelink communication with the terminal device.

In an example, among the plurality of carrier frequencies, a carrier frequency used for sidelink communication with more peer terminal devices may have a higher priority to be used by the peer terminal device for transmitting the sidelink synchronization information.

In the block 410, the terminal device may receive the sidelink synchronization information on a first number of, at least a second number of, or at most a third number of, carrier frequencies for sidelink communication with the peer terminal device. Here, the first number, the second number, or the third number may be configured by a network node, and/or may be dependent on one or more of: the terminal device, a type (e.g., broadcast, multicast, or unicast) of sidelink communication with the peer terminal device, a service type associated with sidelink communication with the peer terminal device, or a frequency band of the first, second, or third number of carrier frequencies.

In an example, for each carrier frequency used for sidelink communication with the peer terminal device, the sidelink synchronization information may be transmitted by the peer terminal device to the terminal device on the carrier frequency when:
the peer terminal device is not configured with a list of candidate synchronization carrier frequencies for the terminal device,
the peer terminal device is configured with a list of candidate synchronization carrier frequencies, but the list does not include any carrier frequency selected by the peer terminal device for sidelink communication with the terminal device, or the carrier frequency is selected as a synchronization carrier frequency, or
the peer terminal device is configured with a list of candidate synchronization carrier frequencies that includes the carrier frequency, and for the terminal device, the peer terminal device has selected another carrier frequency as a synchronization carrier frequency and the peer terminal device is capable of transmitting the sidelink synchronization information on the carrier frequency.

In addition, the sidelink synchronization information may be transmitted by the peer terminal device to the terminal device when:
the peer terminal device is in an RRC connected state and is configured by a network node to transmit the sidelink synchronization information to the terminal device,
the peer terminal device is in coverage and measured Uu RSRP is lower than a configured threshold for the terminal device,
the peer terminal device is out of coverage and selects a GNSS as a synchronization reference source, or
the peer terminal device is out of coverage and not directly synchronized to the GNSS, and has no selected synchronization reference terminal device or has a selected synchronization reference terminal device but measured sidelink RSRP to the selected synchronization reference terminal device on the at least one carrier frequency is lower than a preconfigured threshold for the terminal device.

For further details of the carrier frequency (frequencies) for the Rx UE to receive the sidelink synchronization information from the Tx UE, reference can be made to the above description of the method 100 performed at the Tx UE.

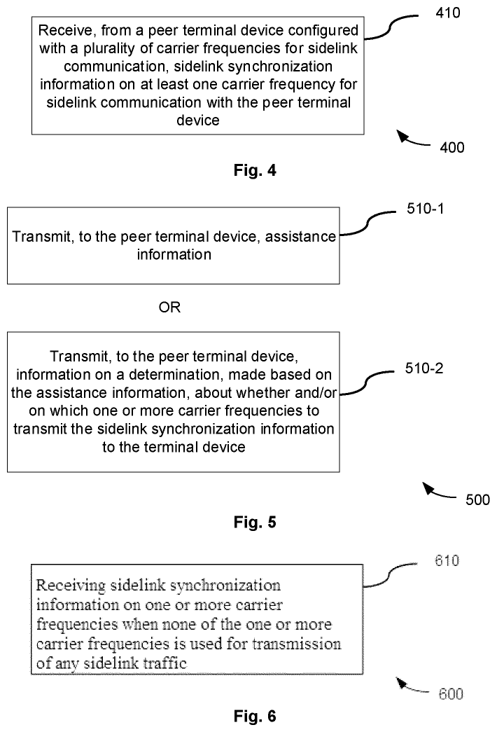

FIG. 5 is a flowchart illustrating a method 500 according to an embodiment of the present disclosure. The method 500 may be performed at a terminal device, e.g., an Rx UE in the sense that it is to receive sidelink synchronization information from a peer terminal device (Tx UE in the sense that it is to transmit sidelink synchronization information). The terminal device is configured for unicast sidelink communication with the peer terminal device.

At block 510-1, the terminal device transmits, to the peer terminal device, assistance information. Here, the assistance information includes one or more of: a list of carrier frequencies on which the terminal device is to monitor, is capable of monitoring, or prefers to monitor, sidelink synchronization information from the peer terminal device, or a synchronization reference resource (e.g., GNSS or network node) selected by the terminal device.

In an example, no sidelink synchronization information from the peer terminal device may be expected when the terminal device uses the same synchronization reference resource as selected by the terminal device.

Alternatively, at block 510-2, the terminal device transmits, to the peer terminal device, information on a determination, made based on the assistance information, about whether and/or on which one or more carrier frequencies to transmit the sidelink synchronization information to the terminal device.

For example, the terminal device may transmit the assistance information to a network node (e.g., a serving gNB), receive the information on the determination from the network node, and then in the block 510-2 transmit the information on the determination to the peer terminal device

In an example, the determination not to transmit the sidelink synchronization information to the terminal device may be made when the peer terminal device uses the same synchronization reference resource as selected by the terminal device.

For further details on whether and on which carrier frequency (frequencies) the Rx UE is to receive the sidelink synchronization information from the Tx UE, reference can be made to the above description of the method 200 performed at the Tx UE.

FIG. 6 is a flowchart illustrating a method 600 according to an embodiment of the present disclosure. The method 600 may be performed at a terminal device, e.g., an Rx UE in the sense that it is to receive sidelink synchronization information from a peer terminal device (Tx UE in the sense that it is to transmit sidelink synchronization information).

At block 610, the terminal device receives sidelink synchronization information on one or more carrier frequencies when none of the one or more carrier frequencies is used for transmission of any sidelink traffic.

In an example, the one or more carrier frequencies may be one or more carrier frequencies configured for legacy (e.g., Rel-16) sidelink communication. Alternatively, the one or more carrier frequencies may include carrier frequencies specific to different releases or services.

For further details of the carrier frequency (frequencies) for the Rx UE to receive the sidelink synchronization information from the Tx UE, reference can be made to the above description of the method 300 performed at the Tx UE.

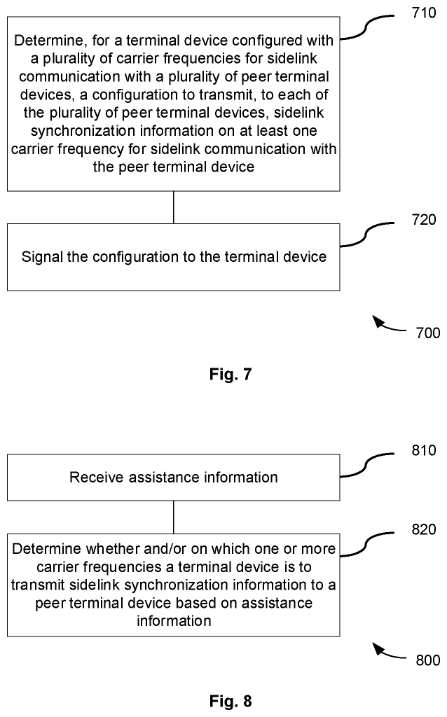

FIG. 7 is a flowchart illustrating a method 700 according to an embodiment of the present disclosure. The method 700 may be performed at a network node, e.g., a serving gNB of a terminal device, e.g., a Tx UE in the sense that it is to transmit sidelink synchronization information. The terminal device is configured with a plurality of carrier frequencies for sidelink communication with a plurality of peer terminal devices (destinations, or Rx UEs in the sense that they are to receive sidelink synchronization information).

At block 710, the network node determines, for the terminal device, a configuration to transmit, to each of the plurality of peer terminal devices, sidelink synchronization information on at least one carrier frequency for sidelink communication with the peer terminal device.

At block 720, the network node signals the configuration to the terminal device.

In an example, the configuration may configure, for at least one of the plurality of peer terminal devices, the terminal device to transmit the sidelink synchronization information on a first number of, at least a second number of, or at most a third number of, carrier frequencies for sidelink communication with the peer terminal device.

In an example, the first number, the second number, or the third number may be dependent on one or more of: the peer terminal device, a type of sidelink communication with the peer terminal device, a service type associated with sidelink communication with the peer terminal device, or a frequency band of the first, second, or third number of carrier frequencies.

In an example, the network node may further signal, to the terminal device, a list of candidate synchronization carrier frequencies for each of at least one of the plurality of peer terminal devices.

In an example, for each peer terminal device, the network node may signal, to the terminal device, a threshold of measured Uu RSRP for the peer terminal device, or signal, to the terminal device, a threshold of measured sidelink RSRP to a selected synchronization reference terminal device for the peer terminal device.

For further details of the carrier frequency (frequencies) configured for the Tx UE to transmit the sidelink synchronization information to the Rx UE, reference can be made to the above description of the method 100 performed at the Tx UE.

FIG. 8 is a flowchart illustrating a method 800 according to an embodiment of the present disclosure. The method 800 may be performed at a network node, e.g., a serving gNB of a terminal device, e.g., a Tx UE in the sense that it is to transmit sidelink synchronization information or an Rx UE in the sense that it is to receive sidelink synchronization information.

At block 810, the network node receives assistance information.

At block 820, the network node determines whether and/or on which one or more carrier frequencies a terminal device is to transmit sidelink synchronization information to a peer terminal device based on assistance information.

Here, the assistance information includes one or more of: a list of carrier frequencies on which the peer terminal device is to monitor, is capable of monitoring, or prefers to monitor, sidelink synchronization information from the terminal device, or a synchronization reference resource selected by the peer terminal device.

In an example, in the block 820, the network node may determine that the terminal device is not to transmit the sidelink synchronization information to the peer terminal device when the terminal device uses the same synchronization reference resource as selected by the peer terminal device.

In an example, the network node may be a serving network node of the terminal device and the assistance information is received from the terminal device. The network node may further transmit, to the terminal device, information on whether and/or on which one or more carrier frequencies the terminal device is to transmit the sidelink synchronization information to the peer terminal device.

Alternatively, the network node may be a serving network node of the peer terminal device and the assistance information is received from the peer terminal device. The network node may further transmit, to the peer terminal device or a serving network node of the terminal device, information on whether and/or on which one or more carrier frequencies the terminal device is to transmit the sidelink synchronization information to the peer terminal device. In another example, the network node may transmit the information to a serving gNB of the terminal device for forwarding to the terminal device.

For further details on whether and on which carrier frequency (frequencies) the sidelink synchronization information is to be transmitted, reference can be made to the above description of the method 200 performed at the Tx UE.

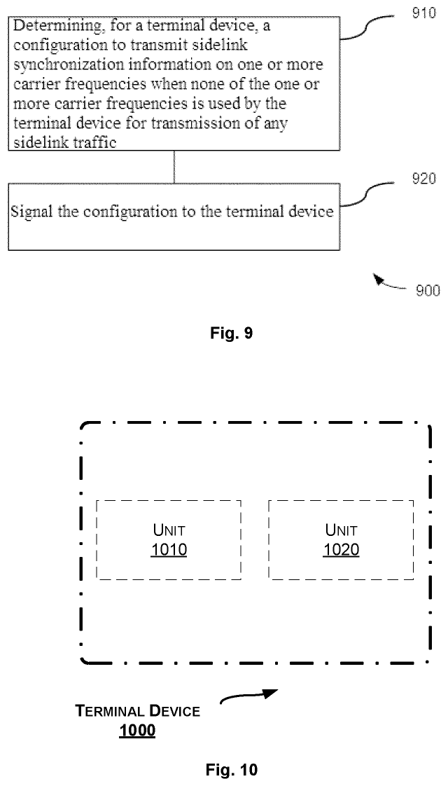

FIG. 9 is a flowchart illustrating a method 900 according to an embodiment of the present disclosure. The method 900 may be performed at a network node, e.g., a serving gNB of a terminal device, e.g., a Tx UE in the sense that it is to transmit sidelink synchronization information to a peer terminal device, e.g., an Rx UE in the sense that it is to receive sidelink synchronization information.

At block 910, the network node determines, for a terminal device, a configuration to transmit sidelink synchronization information on one or more carrier frequencies when none of the one or more carrier frequencies is used by the terminal device for transmission of any sidelink traffic.

At block 920, the terminal device signals the configuration to the terminal device.

In an example, the one or more carrier frequencies may be one or more carrier frequencies configured for legacy (e.g., Rel-16) sidelink communication. Alternatively, the one or more carrier frequencies may include carrier frequencies specific to different releases or services.

For further details of the carrier frequency (frequencies) for the Tx UE to transmit the sidelink synchronization information, reference can be made to the above description of the method 300 performed at the Tx UE.

In the embodiments of the present disclosure, signaling between the terminal device and the peer terminal device(s), including but not limited to the assistance information or the information on the determination about whether and/or on which one or more carrier frequencies to transmit the sidelink synchronization information, may be transmitted/received using RRC signaling (e.g., PC5-RRC), PC5-S (e.g., discovery, unicast link establishment request/response), MAC CE, control PDU of a protocol layer (e.g., Service Data Adaptation Protocol (SDAP), Packet Data Convergence Protocol (PDCP), Radio Link Control (RLC), or an adaptation layer in case of sidelink relay), or L1 signaling (e.g., Physical Sidelink Shared Channel (PSSCH), Physical Sidelink Control Channel (PSCCH), or Physical Sidelink Feedback Channel (PSFCH)). In addition, signaling between the terminal device and the network node, including but not limited to the configuration to transmit sidelink synchronization information, the assistance information, or the information on the determination about whether and/or on which one or more carrier frequencies to transmit the sidelink synchronization information, may be transmitted/received using RRC signaling (common and/or dedicated), MAC CE, paging message, control PDU of a protocol layer (e.g., SDAP, PDCP, RLC, or an adaptation layer in case of sidelink relay), or L1 signaling (e.g., Physical Random Access Channel (PRACH), Physical Uplink Control Channel (PUCCH), or Physical Downlink Control Channel (PDCCH)).

Correspondingly to the methods 100˜600 as described above, a terminal device is provided. FIG. 10 is a block diagram of a terminal device 1000 according to an embodiment of the present disclosure.

The terminal device 1000 may be configured with a plurality of carrier frequencies for sidelink communication with a plurality of peer terminal devices. The terminal device may be operative to perform the method 100 as described above in connection with FIG. 1. In particular, the terminal device 1000 may include a unit 1010 configured to transmit, to each of the plurality of peer terminal devices, sidelink synchronization information on at least one carrier frequency for sidelink communication with the peer terminal device.

In an embodiment, for at least one of the plurality of peer terminal devices, the number of the at least one carrier frequency for sidelink communication with the peer terminal device may be less than the number of all carrier frequencies for sidelink communication with the peer terminal device.

In an embodiment, the sidelink synchronization information may be transmitted when:
the terminal device is not configured with a list of candidate synchronization carrier frequencies, or
the terminal device is configured with a list of candidate synchronization carrier frequencies and the list does not include any carrier frequency used for sidelink communication with the peer terminal device.

In an embodiment, among the plurality of carrier frequencies, a carrier frequency used for sidelink communication with more peer terminal devices may have a higher priority to be used for transmitting the sidelink synchronization information.

In an embodiment, for at least one of the plurality of peer terminal devices, the operation of transmitting, to each of the at least one peer terminal device, the sidelink synchronization information on at least one carrier frequency for sidelink communication with the peer terminal device may include: transmitting the sidelink synchronization information on a first number of, at least a second number of, or at most a third number of, carrier frequencies for sidelink communication with the peer terminal device.

In an embodiment, the first number, the second number, or the third number may be configured by a network node, and/or may be dependent on one or more of: the peer terminal device, a type of sidelink communication with the peer terminal device, a service type associated with sidelink communication with the peer terminal device, or a frequency band of the first, second, or third number of carrier frequencies.

In an embodiment, the type of sidelink communication may include broadcast, multicast, or unicast.

In an embodiment, for each carrier frequency used for sidelink communication with each peer terminal device, the sidelink synchronization information may be transmitted to the peer terminal device on the carrier frequency when:
the terminal device is not configured with a list of candidate synchronization carrier frequencies for the peer terminal device,
the terminal device is configured with a list of candidate synchronization carrier frequencies, but the list does not include any carrier frequency selected by the terminal device for sidelink communication with the peer terminal device, or the carrier frequency is selected as a synchronization carrier frequency, or
the terminal device is configured with a list of candidate synchronization carrier frequencies that includes the carrier frequency, and for the peer terminal device, the terminal device has selected another carrier frequency as a synchronization carrier frequency and the terminal device is capable of transmitting the sidelink synchronization information on the carrier frequency.

In an embodiment, for each peer terminal device, the sidelink synchronization information may be transmitted to the peer terminal device when:
the terminal device is in a Radio Resource Control (RRC) connected state and is configured by a network node to transmit the sidelink synchronization information to the peer terminal device,
the terminal device is in coverage and measured Uu Reference Signal Received Power (RSRP) is lower than a configured threshold for the peer terminal device,
the terminal device is out of coverage and selects a Global Navigation Satellite System (GNSS) as a synchronization reference source, or
the terminal device is out of coverage and not directly synchronized to the GNSS, and has no selected synchronization reference terminal device or has a selected synchronization reference terminal device but measured sidelink RSRP to the selected synchronization reference terminal device is lower than a preconfigured threshold for the peer terminal device.

Alternatively, the terminal device 1000 may be configured with one or more carrier frequencies for unicast sidelink communication with a peer terminal device. The terminal device may be operative to perform the method 200 as described above in connection with FIG. 2. In particular, the terminal device 1000 may include a unit 1010 configured to determine whether and/or on which one or more carrier frequencies to transmit sidelink synchronization information to the peer terminal device based on assistance information. Alternatively, the terminal device 1000 may include a unit 1020 configured to receive information on a determination, made based on the assistance information, about whether and/or on which one or more carrier frequencies to transmit the sidelink synchronization information to the peer terminal device. The assistance information includes one or more of: a list of carrier frequencies on which the peer terminal device is to monitor, is capable of monitoring, or prefers to monitor, sidelink synchronization information from the terminal device, or a synchronization reference resource selected by the peer terminal device.

In an embodiment, the unit 1010 may be configured to determine not to transmit the sidelink synchronization information to the peer terminal device when the terminal device uses the same synchronization reference resource as selected by the peer terminal device. Alternatively, the determination not to transmit the sidelink synchronization information to the peer terminal device may be made when the terminal device uses the same synchronization reference resource as selected by the peer terminal device.

In an embodiment, the terminal device 1000 may further include a unit configured to receive the assistance information from the peer terminal device.

In an embodiment, the terminal device 1000 may further include: a unit configured to receive the assistance information from the peer terminal device; and a unit configured to transmit the assistance information to a network node. The information on the determination may be received from the network node.

In an embodiment, the information on the determination may be received from the peer terminal device.

In an embodiment, the information on the determination may be received from the peer terminal device using: RRC signaling, PC5 Signaling (PC5-S), Medium Access Control (MAC) Control Element (CE), control Protocol Data Unit (PDU) of a protocol layer, or Layer 1 (L1) signaling, or the information on the determination may be received from the network node using: RRC signaling, MAC CE, paging message, control PDU of a protocol layer, or L1 signaling.

Alternatively, the terminal device 1000 may be operative to perform the method 300 as described above in connection with FIG. 3. In particular, the terminal device 1000 may include a unit 1010 configured to transmit sidelink synchronization information on one or more carrier frequencies when none of the one or more carrier frequencies is used for transmission of any sidelink traffic.

In an embodiment, the one or more carrier frequencies may include one or more carrier frequencies configured for legacy sidelink communication.

In an embodiment, the one or more carrier frequencies may include carrier frequencies specific to different releases or services.

Alternatively, the terminal device 1000 may be operative to perform the method 400 as described above in connection with FIG. 4. In particular, the terminal device 1000 may include a unit 1010 configured to receive, from a peer terminal device configured with a plurality of carrier frequencies for sidelink communication, sidelink synchronization information on at least one carrier frequency for sidelink communication with the peer terminal device.

In an embodiment, the number of the at least one carrier frequency for sidelink communication with the peer terminal device may be less than the number of all carrier frequencies for sidelink communication with the peer terminal device.

In an embodiment, the sidelink synchronization information may be transmitted by the peer terminal device when:
the peer terminal device is not configured with a list of candidate synchronization carrier frequencies, or
the peer terminal device is configured with a list of candidate synchronization carrier frequencies and the list does not include any carrier frequency used for sidelink communication with the terminal device.

In an embodiment, among the plurality of carrier frequencies, a carrier frequency used for sidelink communication with more peer terminal devices may have a higher priority to be used by the peer terminal device for transmitting the sidelink synchronization information.

In an embodiment, the unit 1010 may be configured to receive the sidelink synchronization information on a first number of, at least a second number of, or at most a third number of, carrier frequencies for sidelink communication with the peer terminal device.

In an embodiment, the first number, the second number, or the third number may be configured by a network node, and/or may be dependent on one or more of: the terminal device, a type of sidelink communication with the peer terminal device, a service type associated with sidelink communication with the peer terminal device, or a frequency band of the first, second, or third number of carrier frequencies.

In an embodiment, the type of sidelink communication may include broadcast, multicast, or unicast.

In an embodiment, for each carrier frequency used for sidelink communication with the peer terminal device, the sidelink synchronization information may be transmitted by the peer terminal device to the terminal device on the carrier frequency when:
the peer terminal device is not configured with a list of candidate synchronization carrier frequencies for the terminal device,
the peer terminal device is configured with a list of candidate synchronization carrier frequencies, but the list does not include any carrier frequency selected by the peer terminal device for sidelink communication with the terminal device, or the carrier frequency is selected as a synchronization carrier frequency, or
the peer terminal device is configured with a list of candidate synchronization carrier frequencies that includes the carrier frequency, and for the terminal device, the peer terminal device has selected another carrier frequency as a synchronization carrier frequency and the peer terminal device is capable of transmitting the sidelink synchronization information on the carrier frequency.

In an embodiment, the sidelink synchronization information may be transmitted by the peer terminal device to the terminal device when:
the peer terminal device is in an RRC connected state and is configured by a network node to transmit the sidelink synchronization information to the terminal device,
the peer terminal device is in coverage and measured Uu RSRP is lower than a configured threshold for the terminal device,
the peer terminal device is out of coverage and selects a GNSS as a synchronization reference source, or
the peer terminal device is out of coverage and not directly synchronized to the GNSS, and has no selected synchronization reference terminal device or has a selected synchronization reference terminal device but measured sidelink RSRP to the selected synchronization reference terminal device on the at least one carrier frequency is lower than a preconfigured threshold for the terminal device.

Alternatively, the terminal device 1000 may be configured for unicast sidelink communication with a peer terminal device. The terminal device 1000 may be operative to perform the method 500 as described above in connection with FIG. 5. In particular, the terminal device 1000 may include a unit 1010 configured to transmit, to the peer terminal device, assistance information. Alternatively, the terminal device 1000 may include a unit 1020 configured to transmit, to the peer terminal device, information on a determination, made based on the assistance information, about whether and/or on which one or more carrier frequencies to transmit the sidelink synchronization information to the terminal device. The assistance information may include one or more of: a list of carrier frequencies on which the terminal device is to monitor, is capable of monitoring, or prefers to monitor, sidelink synchronization information from the peer terminal device, or a synchronization reference resource selected by the terminal device.

In an embodiment, no sidelink synchronization information from the peer terminal device may be expected when the terminal device uses the same synchronization reference resource as selected by the terminal device, or the determination not to transmit the sidelink synchronization information to the terminal device may be made when the peer terminal device uses the same synchronization reference resource as selected by the terminal device.

In an embodiment, the terminal device 1000 may further include a unit configured to transmit the assistance information to a network node; and a unit configured to receive the information on the determination from the network node.

In an embodiment, the assistance information or the information on the determination may be transmitted to the peer terminal device using: RRC signaling, PC5-S, MAC CE, control PDU of a protocol layer, or L1 signaling.

Alternatively, the terminal device 1000 may be operative to perform the method 600 as described above in connection with FIG. 6. In particular, the terminal device 1000 may include a unit 1010 configured to receive sidelink synchronization information on one or more carrier frequencies when none of the one or more carrier frequencies is used for transmission of any sidelink traffic.

In an embodiment, the one or more carrier frequencies may include one or more carrier frequencies configured for legacy sidelink communication.

In an embodiment, the one or more carrier frequencies may include carrier frequencies specific to different releases or services.

The unit 1010, and optionally the unit 1020, can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 1, 2, 3, 4, 5, or 6.

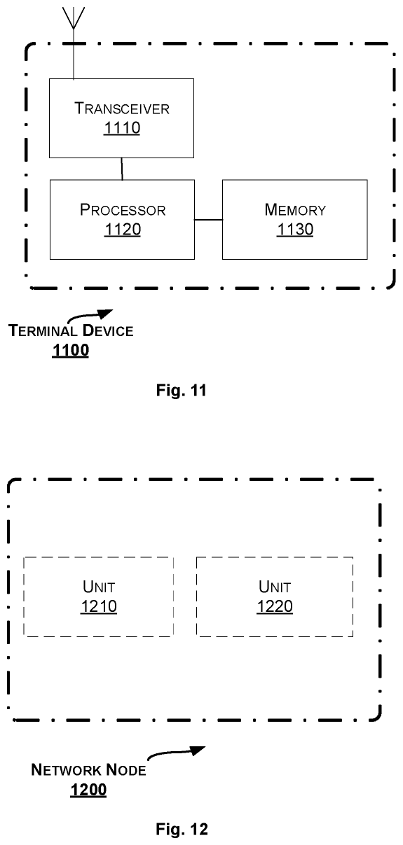

FIG. 11 is a block diagram of a terminal device 1100 according to another embodiment of the present disclosure.

The terminal device 1100 includes a transceiver 1110, a processor 1120 and a memory 1130.

The terminal device 1100 may be configured with a plurality of carrier frequencies for sidelink communication with a plurality of peer terminal devices. The memory 1130 may contain instructions executable by the processor 1120 whereby the terminal device 1100 is operative to perform the actions, e.g., of the procedure described earlier in conjunction with FIG. 1. Particularly, the memory 1130 contains instructions executable by the processor 1120 whereby the terminal device 1100 is operative to: transmit, to each of the plurality of peer terminal devices, sidelink synchronization information on at least one carrier frequency for sidelink communication with the peer terminal device.

In an embodiment, for at least one of the plurality of peer terminal devices, the number of the at least one carrier frequency for sidelink communication with the peer terminal device may be less than the number of all carrier frequencies for sidelink communication with the peer terminal device.

In an embodiment, the sidelink synchronization information may be transmitted when:
the terminal device is not configured with a list of candidate synchronization carrier frequencies, or
the terminal device is configured with a list of candidate synchronization carrier frequencies and the list does not include any carrier frequency used for sidelink communication with the peer terminal device.

In an embodiment, among the plurality of carrier frequencies, a carrier frequency used for sidelink communication with more peer terminal devices may have a higher priority to be used for transmitting the sidelink synchronization information.

In an embodiment, for at least one of the plurality of peer terminal devices, the operation of transmitting, to each of the at least one peer terminal device, the sidelink synchronization information on at least one carrier frequency for sidelink communication with the peer terminal device may include: transmitting the sidelink synchronization information on a first number of, at least a second number of, or at most a third number of, carrier frequencies for sidelink communication with the peer terminal device.

In an embodiment, the first number, the second number, or the third number may be configured by a network node, and/or may be dependent on one or more of: the peer terminal device, a type of sidelink communication with the peer terminal device, a service type associated with sidelink communication with the peer terminal device, or a frequency band of the first, second, or third number of carrier frequencies.

In an embodiment, the type of sidelink communication may include broadcast, multicast, or unicast.

In an embodiment, for each carrier frequency used for sidelink communication with each peer terminal device, the sidelink synchronization information may be transmitted to the peer terminal device on the carrier frequency when:
the terminal device is not configured with a list of candidate synchronization carrier frequencies for the peer terminal device,
the terminal device is configured with a list of candidate synchronization carrier frequencies, but the list does not include any carrier frequency selected by the terminal device for sidelink communication with the peer terminal device, or the carrier frequency is selected as a synchronization carrier frequency, or
the terminal device is configured with a list of candidate synchronization carrier frequencies that includes the carrier frequency, and for the peer terminal device, the terminal device has selected another carrier frequency as a synchronization carrier frequency and the terminal device is capable of transmitting the sidelink synchronization information on the carrier frequency.

In an embodiment, for each peer terminal device, the sidelink synchronization information may be transmitted to the peer terminal device when:
the terminal device is in a Radio Resource Control (RRC) connected state and is configured by a network node to transmit the sidelink synchronization information to the peer terminal device,
the terminal device is in coverage and measured Uu Reference Signal Received Power (RSRP) is lower than a configured threshold for the peer terminal device,
the terminal device is out of coverage and selects a Global Navigation Satellite System (GNSS) as a synchronization reference source, or
the terminal device is out of coverage and not directly synchronized to the GNSS, and has no selected synchronization reference terminal device or has a selected synchronization reference terminal device but measured sidelink RSRP to the selected synchronization reference terminal device is lower than a preconfigured threshold for the peer terminal device.

Alternatively, the terminal device 1100 may be configured with one or more carrier frequencies for unicast sidelink communication with a peer terminal device. The memory 1130 may contain instructions executable by the processor 1120 whereby the terminal device 1100 is operative to perform the actions, e.g., of the procedure described earlier in conjunction with FIG. 2. Particularly, the memory 1130 contains instructions executable by the processor 1120 whereby the terminal device 1100 is operative to: determine whether and/or on which one or more carrier frequencies to transmit sidelink synchronization information to the peer terminal device based on assistance information; or receive information on a determination, made based on the assistance information, about whether and/or on which one or more carrier frequencies to transmit the sidelink synchronization information to the peer terminal device. The assistance information includes one or more of: a list of carrier frequencies on which the peer terminal device is to monitor, is capable of monitoring, or prefers to monitor, sidelink synchronization information from the terminal device, or a synchronization reference resource selected by the peer terminal device.

In an embodiment, the operation of determining may include: determining not to transmit the sidelink synchronization information to the peer terminal device when the terminal device uses the same synchronization reference resource as selected by the peer terminal device, or the determination not to transmit the sidelink synchronization information to the peer terminal device may be made when the terminal device uses the same synchronization reference resource as selected by the peer terminal device.

In an embodiment, the memory 1130 may further contain instructions executable by the processor 1120 whereby the terminal device 1100 is operative to, prior to the operation of determining: receive the assistance information from the peer terminal device.

In an embodiment, the memory 1130 may further contain instructions executable by the processor 1120 whereby the terminal device 1100 is operative to, prior to the operation of receiving: receive the assistance information from the peer terminal device; and transmit the assistance information to a network node. The information on the determination may be received from the network node.

In an embodiment, the information on the determination may be received from the peer terminal device.

In an embodiment, the information on the determination may be received from the peer terminal device using: RRC signaling, PC5 Signaling (PC5-S), Medium Access Control (MAC) Control Element (CE), control Protocol Data Unit (PDU) of a protocol layer, or Layer 1 (L1) signaling, or the information on the determination may be received from the network node using: RRC signaling, MAC CE, paging message, control PDU of a protocol layer, or L1 signaling.

Alternatively, the memory 1130 may contain instructions executable by the processor 1120 whereby the terminal device 1100 is operative to perform the actions, e.g., of the procedure described earlier in conjunction with FIG. 3. Particularly, the memory 1130 contains instructions executable by the processor 1120 whereby the terminal device 1100 is operative to: transmit sidelink synchronization information on one or more carrier frequencies when none of the one or more carrier frequencies is used for transmission of any sidelink traffic.

In an embodiment, the one or more carrier frequencies may include one or more carrier frequencies configured for legacy sidelink communication.

In an embodiment, the one or more carrier frequencies may include carrier frequencies specific to different releases or services.

Alternatively, the memory 1130 may contain instructions executable by the processor 1120 whereby the terminal device 1100 is operative to perform the actions, e.g., of the procedure described earlier in conjunction with FIG. 4.

Particularly, the memory 1130 contains instructions executable by the processor 1120 whereby the terminal device 1100 is operative to: receive, from a peer terminal device configured with a plurality of carrier frequencies for sidelink communication, sidelink synchronization information on at least one carrier frequency for sidelink communication with the peer terminal device.

In an embodiment, the number of the at least one carrier frequency for sidelink communication with the peer terminal device may be less than the number of all carrier frequencies for sidelink communication with the peer terminal device.

In an embodiment, the sidelink synchronization information may be transmitted by the peer terminal device when:
the peer terminal device is not configured with a list of candidate synchronization carrier frequencies, or
the peer terminal device is configured with a list of candidate synchronization carrier frequencies and the list does not include any carrier frequency used for sidelink communication with the terminal device.

In an embodiment, among the plurality of carrier frequencies, a carrier frequency used for sidelink communication with more peer terminal devices may have a higher priority to be used by the peer terminal device for transmitting the sidelink synchronization information.

In an embodiment, the operation of receiving the sidelink synchronization information on at least one carrier frequency may include: receiving the sidelink synchronization information on a first number of, at least a second number of, or at most a third number of, carrier frequencies for sidelink communication with the peer terminal device.

In an embodiment, the first number, the second number, or the third number may be configured by a network node, and/or may be dependent on one or more of: the terminal device, a type of sidelink communication with the peer terminal device, a service type associated with sidelink communication with the peer terminal device, or a frequency band of the first, second, or third number of carrier frequencies.

In an embodiment, the type of sidelink communication may include broadcast, multicast, or unicast.

In an embodiment, for each carrier frequency used for sidelink communication with the peer terminal device, the sidelink synchronization information may be transmitted by the peer terminal device to the terminal device on the carrier frequency when:
the peer terminal device is not configured with a list of candidate synchronization carrier frequencies for the terminal device,
the peer terminal device is configured with a list of candidate synchronization carrier frequencies, but the list does not include any carrier frequency selected by the peer terminal device for sidelink communication with the terminal device, or the carrier frequency is selected as a synchronization carrier frequency, or
the peer terminal device is configured with a list of candidate synchronization carrier frequencies that includes the carrier frequency, and for the terminal device, the peer terminal device has selected another carrier frequency as a synchronization carrier frequency and the peer terminal device is capable of transmitting the sidelink synchronization information on the carrier frequency.

In an embodiment, the sidelink synchronization information may be transmitted by the peer terminal device to the terminal device when:
the peer terminal device is in an RRC connected state and is configured by a network node to transmit the sidelink synchronization information to the terminal device,
the peer terminal device is in coverage and measured Uu RSRP is lower than a configured threshold for the terminal device,
the peer terminal device is out of coverage and selects a GNSS as a synchronization reference source, or
the peer terminal device is out of coverage and not directly synchronized to the GNSS, and has no selected synchronization reference terminal device or has a selected synchronization reference terminal device but measured sidelink RSRP to the selected synchronization reference terminal device on the at least one carrier frequency is lower than a preconfigured threshold for the terminal device.

Alternatively, the terminal device 1100 may be configured for unicast sidelink communication with a peer terminal device. The memory 1130 may contain instructions executable by the processor 1120 whereby the terminal device 1100 is operative to perform the actions, e.g., of the procedure described earlier in conjunction with FIG. 5. Particularly, the memory 1130 contains instructions executable by the processor 1120 whereby the terminal device 1100 is operative to: transmit, to the peer terminal device, assistance information; or transmit, to the peer terminal device, information on a determination, made based on the assistance information, about whether and/or on which one or more carrier frequencies to transmit the sidelink synchronization information to the terminal device. The assistance information may include one or more of: a list of carrier frequencies on which the terminal device is to monitor, is capable of monitoring, or prefers to monitor, sidelink synchronization information from the peer terminal device, or a synchronization reference resource selected by the terminal device.

In an embodiment, no sidelink synchronization information from the peer terminal device may be expected when the terminal device uses the same synchronization reference resource as selected by the terminal device, or the determination not to transmit the sidelink synchronization information to the terminal device may be made when the peer terminal device uses the same synchronization reference resource as selected by the terminal device.

In an embodiment, the memory 1130 may further contain instructions executable by the processor 1120 whereby the terminal device 1100 is operative to, prior to transmitting the information on the determination: transmit the assistance information to a network node; and receiving the information on the determination from the network node.

In an embodiment, the assistance information or the information on the determination may be transmitted to the peer terminal device using: RRC signaling, PC5-S, MAC CE, control PDU of a protocol layer, or L1 signaling.

The memory 1130 may contain instructions executable by the processor 1120 whereby the terminal device 1100 is operative to perform the actions, e.g., of the procedure described earlier in conjunction with FIG. 6. Particularly, the memory 1130 contains instructions executable by the processor 1120 whereby the terminal device 1100 is operative to: receive sidelink synchronization information on one or more carrier frequencies when none of the one or more carrier frequencies is used for transmission of any sidelink traffic.

In an embodiment, the one or more carrier frequencies may include one or more carrier frequencies configured for legacy sidelink communication.

In an embodiment, the one or more carrier frequencies may include carrier frequencies specific to different releases or services.

Correspondingly to the methods 700˜900 as described above, a network node is provided. FIG. 12 is a block diagram of a network node 1200 according to an embodiment of the present disclosure.

The network node 1200 may be operative to perform the method 700 as described above in connection with FIG. 7. In particular, the network node 1200 may include a unit 1210 configured to determine, for a terminal device configured with a plurality of carrier frequencies for sidelink communication with a plurality of peer terminal devices, a configuration to transmit, to each of the plurality of peer terminal devices, sidelink synchronization information on at least one carrier frequency for sidelink communication with the peer terminal device. The network node 1200 may further include a unit 1220 configured to signal the configuration to the terminal device.

In an embodiment, the configuration may configure, for at least one of the plurality of peer terminal devices, the terminal device to transmit the sidelink synchronization information on a first number of, at least a second number of, or at most a third number of, carrier frequencies for sidelink communication with the peer terminal device.

In an embodiment, the first number, the second number, or the third number may be dependent on one or more of: the peer terminal device, a type of sidelink communication with the peer terminal device, a service type associated with sidelink communication with the peer terminal device, or a frequency band of the first, second, or third number of carrier frequencies.

In an embodiment, the unit 1220 may be further configured to signal, to the terminal device, a list of candidate synchronization carrier frequencies for each of at least one of the plurality of peer terminal devices.

In an embodiment, the unit 1220 may be further configured to, for each peer terminal device: signal, to the terminal device, a threshold of measured Uu RSRP for the peer terminal device; or signal, to the terminal device, a threshold of measured sidelink RSRP to a selected synchronization reference terminal device for the peer terminal device.

Alternatively, the network node 1200 may be operative to perform the method 800 as described above in connection with FIG. 8. In particular, the network node 1200 may include a unit 1210 configured to receive assistance information. The network node 1200 may further include a unit 1220 configured to determine whether and/or on which one or more carrier frequencies a terminal device is to transmit sidelink synchronization information to a peer terminal device based on assistance information. The assistance information may include one or more of: a list of carrier frequencies on which the peer terminal device is to monitor, is capable of monitoring, or prefers to monitor, sidelink synchronization information from the terminal device, or a synchronization reference resource selected by the peer terminal device.

In an embodiment, the unit 1220 may be configured to determine that the terminal device is not to transmit the sidelink synchronization information to the peer terminal device when the terminal device uses the same synchronization reference resource as selected by the peer terminal device.

In an embodiment, the network node may be a serving network node of the terminal device and the assistance information may be received from the terminal device. The network node 1200 may further include a unit configured to transmit, to the terminal device, information on whether and/or on which one or more carrier frequencies the terminal device is to transmit the sidelink synchronization information to the peer terminal device.

In an embodiment, the network node may be a serving network node of the peer terminal device and the assistance information may be received from the peer terminal device. The network node 1200 may further include a unit configured to transmit, to the peer terminal device or a serving network node of the terminal device, information on whether and/or on which one or more carrier frequencies the terminal device is to transmit the sidelink synchronization information to the peer terminal device.

In an embodiment, the assistance information may be received using: RRC signaling, MAC CE, paging message, control PDU of a protocol layer, or L1 signaling.

Alternatively, the network node 1200 may be operative to perform the method 900 as described above in connection with FIG. 9. In particular, the network node 1200 may include a unit 1210 configured to determine, for a terminal device, a configuration to transmit sidelink synchronization information on one or more carrier frequencies when none of the one or more carrier frequencies is used by the terminal device for transmission of any sidelink traffic. The network node 1200 may further include a unit 1220 configured to signal the configuration to the terminal device.

In an embodiment, the one or more carrier frequencies may include one or more carrier frequencies configured for legacy sidelink communication.

In an embodiment, the one or more carrier frequencies may include carrier frequencies specific to different releases or services.

The unit 1210 and the unit 1220, can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 7, 8, or 9.

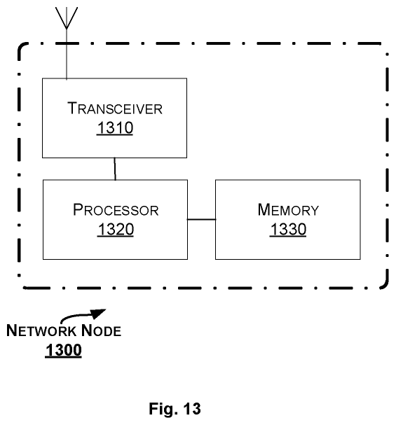

FIG. 13 is a block diagram of a network node 1300 according to another embodiment of the present disclosure.

The network node 1300 includes a transceiver 1310, a processor 1320 and a memory 1330.

The memory 1330 may contain instructions executable by the processor 1320 whereby the network node 1300 is operative to perform the actions, e.g., of the procedure described earlier in conjunction with FIG. 7. Particularly, the memory 1330 contains instructions executable by the processor 1320 whereby the network node 1300 is operative to: determine, for a terminal device configured with a plurality of carrier frequencies for sidelink communication with a plurality of peer terminal devices, a configuration to transmit, to each of the plurality of peer terminal devices, sidelink synchronization information on at least one carrier frequency for sidelink communication with the peer terminal device; and signal the configuration to the terminal device.

In an embodiment, the configuration may configure, for at least one of the plurality of peer terminal devices, the terminal device to transmit the sidelink synchronization information on a first number of, at least a second number of, or at most a third number of, carrier frequencies for sidelink communication with the peer terminal device.

In an embodiment, the first number, the second number, or the third number may be dependent on one or more of: the peer terminal device, a type of sidelink communication with the peer terminal device, a service type associated with sidelink communication with the peer terminal device, or a frequency band of the first, second, or third number of carrier frequencies.

In an embodiment, the memory 1330 may further contain instructions executable by the processor 1320 whereby the network node 1300 is operative to: signal, to the terminal device, a list of candidate synchronization carrier frequencies for each of at least one of the plurality of peer terminal devices.

In an embodiment, the memory 1330 may further contain instructions executable by the processor 1320 whereby the network node 1300 is operative to: for each peer terminal device: signal, to the terminal device, a threshold of measured Uu RSRP for the peer terminal device; or signal, to the terminal device, a threshold of measured sidelink RSRP to a selected synchronization reference terminal device for the peer terminal device.

Alternatively, the memory 1330 may contain instructions executable by the processor 1320 whereby the network node 1300 is operative to perform the actions, e.g., of the procedure described earlier in conjunction with FIG. 8. Particularly, the memory 1330 contains instructions executable by the processor 1320 whereby the network node 1300 is operative to: receive assistance information; and determine whether and/or on which one or more carrier frequencies a terminal device is to transmit sidelink synchronization information to a peer terminal device based on assistance information. The assistance information may include one or more of: a list of carrier frequencies on which the peer terminal device is to monitor, is capable of monitoring, or prefers to monitor, sidelink synchronization information from the terminal device, or a synchronization reference resource selected by the peer terminal device.

In an embodiment, the operation of determining may include: determining that the terminal device is not to transmit the sidelink synchronization information to the peer terminal device when the terminal device uses the same synchronization reference resource as selected by the peer terminal device.

In an embodiment, the network node may be a serving network node of the terminal device and the assistance information may be received from the terminal device. The memory 1330 may further contain instructions executable by the processor 1320 whereby the network node 1300 is operative to: transmit, to the terminal device, information on whether and/or on which one or more carrier frequencies the terminal device is to transmit the sidelink synchronization information to the peer terminal device.

In an embodiment, the network node may be a serving network node of the peer terminal device and the assistance information may be received from the peer terminal device. The memory 1330 may further contain instructions executable by the processor 1320 whereby the network node 1300 is operative to: transmit, to the peer terminal device or a serving network node of the terminal device, information on whether and/or on which one or more carrier frequencies the terminal device is to transmit the sidelink synchronization information to the peer terminal device.

In an embodiment, the assistance information may be received using: RRC signaling, MAC CE, paging message, control PDU of a protocol layer, or L1 signaling.

Alternatively, the memory 1330 may contain instructions executable by the processor 1320 whereby the network node 1300 is operative to perform the actions, e.g., of the procedure described earlier in conjunction with FIG. 9. Particularly, the memory 1330 contains instructions executable by the processor 1320 whereby the network node 1300 is operative to: determine, for a terminal device, a configuration to transmit sidelink synchronization information on one or more carrier frequencies when none of the one or more carrier frequencies is used by the terminal device for transmission of any sidelink traffic; and signal the configuration to the terminal device.

In an embodiment, the one or more carrier frequencies may include one or more carrier frequencies configured for legacy sidelink communication.

In an embodiment, the one or more carrier frequencies may include carrier frequencies specific to different releases or services.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 1120 causes the terminal device 1100 to perform the actions, e.g., of the procedure described earlier in conjunction with FIG. 1, 2, 3, 4, 5, or 6; or code/computer readable instructions, which when executed by the processor 1320 causes the network node 1300 to perform the actions, e.g., of the procedure described earlier in conjunction with FIG. 7, 8, or 9.

The computer program product may be configured as a computer program code structured in computer program modules. The computer program modules could essentially perform the actions of the flow illustrated in FIG. 1, 2, 3, 4, 5, 6, 7, 8, or 9.

The processor may be a single CPU (Central Processing Unit), but could also comprise two or more processing units. For example, the processor may include general purpose microprocessors; instruction set processors and/or related chips sets and/or special purpose microprocessors such as Application Specific Integrated Circuits (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random-Access Memory (RAM), a Read-Only Memory (ROM), or an EEPROM, and the computer program modules described above could in alternative embodiments be distributed on different computer program products in the form of memories.

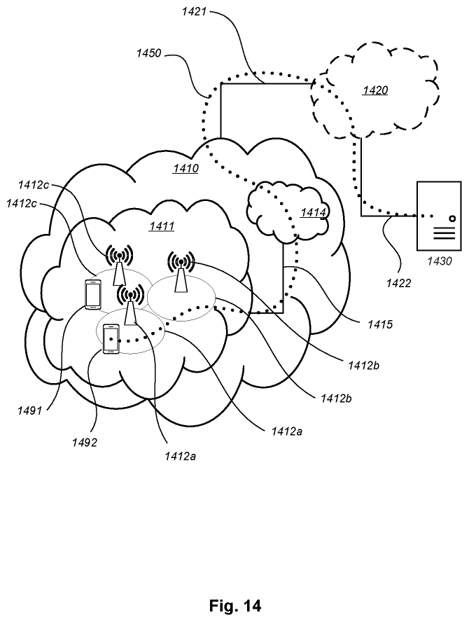

With reference to FIG. 14, in accordance with an embodiment, a communication system includes a telecommunication network 1410, such as a 3GPP-type cellular network, which comprises an access network 1411, such as a radio access network, and a core network 1414. The access network 1411 comprises a plurality of base stations 1412a, 1412b, 1412c, such as NBs, eNBs, gNBs or other types of wireless access points, each defining a corresponding coverage area 1412a, 1412b, 1412c. Each base station 1412a, 1412b, 1412c is connectable to the core network 1414 over a wired or wireless connection 1415. A first UE 1491 located in a coverage area 1412c is configured to wirelessly connect to, or be paged by, the corresponding base station 1412c. A second UE 1492 in a coverage area 1412a is wirelessly connectable to the corresponding base station 1412a. While a plurality of UEs 1491, 1492 are illustrated in this example, the disclosed embodiments are equally applicable to a situation where a sole UE is in the coverage area or where a sole UE is connecting to the corresponding base station 1412.

The telecommunication network 1410 is itself connected to a host computer 1430, which may be embodied in the hardware and/or software of a standalone server, a cloud-implemented server, a distributed server or as processing resources in a server farm. The host computer 1430 may be under the ownership or control of a service provider, or may be operated by the service provider or on behalf of the service provider. Connections 1421 and 1422 between the telecommunication network 1410 and the host computer 1430 may extend directly from the core network 1414 to the host computer 1430 or may go via an optional intermediate network 1420. An intermediate network 1420 may be one of, or a combination of more than one of, a public, private or hosted network; the intermediate network 1420, if any, may be a backbone network or the Internet; in particular, the intermediate network 1420 may comprise two or more sub-networks (not shown).

The communication system of FIG. 14 as a whole enables connectivity between the connected UEs 1491, 1492 and the host computer 1430. The connectivity may be described as an over-the-top (OTT) connection 1450. The host computer 1430 and the connected UEs 1491, 1492 are configured to communicate data and/or signaling via the OTT connection 1450, using the access network 1411, the core network 1414, any intermediate network 1420 and possible further infrastructure (not shown) as intermediaries. The OTT connection 1450 may be transparent in the sense that the participating communication devices through which the OTT connection 1450 passes are unaware of routing of uplink and downlink communications. For example, the base station 1412 may not or need not be informed about the past routing of an incoming downlink communication with data originating from the host computer 1430 to be forwarded (e.g., handed over) to a connected UE 1491. Similarly, the base station 1412 need not be aware of the future routing of an outgoing uplink communication originating from the UE 1491 towards the host computer 1430.

Example implementations, in accordance with an embodiment, of the UE, base station and host computer discussed in the preceding paragraphs will now be described with reference to FIG. 14. In a communication system 1400, a host computer 1410 comprises hardware 1415 including a communication interface 1416 configured to set up and maintain a wired or wireless connection with an interface of a different communication device of the communication system 1400. The host computer 1410 further comprises a processing circuitry 1418, which may have storage and/or processing capabilities. In particular, the processing circuitry 1418 may comprise one or more programmable processors, application-specific integrated circuits, field programmable gate arrays or combinations of these (not shown) adapted to execute instructions. The host computer 1410 further comprises software 1411, which is stored in or accessible by the host computer 1410 and executable by the processing circuitry 1418. The software 1411 includes a host application 1412. The host application 1412 may be operable to provide a service to a remote user, such as UE 1430 connecting via an OTT connection 1450 terminating at the UE 1430 and the host computer 1410. In providing the service to the remote user, the host application 1412 may provide user data which is transmitted using the OTT connection 1450.

The communication system 1400 further includes a base station 1420 provided in a telecommunication system and comprising hardware 1425 enabling it to communicate with the host computer 1410 and with the UE 1430. The hardware 1425 may include a communication interface 1426 for setting up and maintaining a wired or wireless connection with an interface of a different communication device of the communication system 1400, as well as a radio interface 1427 for setting up and maintaining at least a wireless connection 1470 with the UE 1430 located in a coverage area (not shown in FIG. 14) served by the base station 1420. The communication interface 1426 may be configured to facilitate a connection 1460 to the host computer 1410. The connection 1460 may be direct or it may pass through a core network (not shown in FIG. 14) of the telecommunication system and/or through one or more intermediate networks outside the telecommunication system. In the embodiment shown, the hardware 1425 of the base station 1420 further includes a processing circuitry 1428, which may comprise one or more programmable processors, application-specific integrated circuits, field programmable gate arrays or combinations of these (not shown) adapted to execute instructions. The base station 1420 further has software 1421 stored internally or accessible via an external connection.

The communication system 1400 further includes the UE 1430 already referred to. Its hardware 1435 may include a radio interface 1437 configured to set up and maintain a wireless connection 1470 with a base station serving a coverage area in which the UE 1430 is currently located. The hardware 1435 of the UE 1430 further includes a processing circuitry 1438, which may comprise one or more programmable processors, application-specific integrated circuits, field programmable gate arrays or combinations of these (not shown) adapted to execute instructions. The UE 1430 further comprises software 1431, which is stored in or accessible by the UE 1430 and executable by the processing circuitry 1438. The software 1431 includes a client application 1432. The client application 1432 may be operable to provide a service to a human or non-human user via the UE 1430, with the support of the host computer 1410. In the host computer 1410, an executing host application 1412 may communicate with the executing client application 1432 via the OTT connection 1450 terminating at the UE 1430 and the host computer 1410. In providing the service to the user, the client application 1432 may receive request data from the host application 1412 and provide user data in response to the request data. The OTT connection 1450 may transfer both the request data and the user data. The client application 1432 may interact with the user to generate the user data that it provides.

It is noted that the host computer 1410, the base station 1420 and the UE 1430 illustrated in FIG. 14 may be similar or identical to the host computer 1430, one of base stations 1412a, 1412b, 1412c and one of UEs 1491, 1492 of FIG. 14, respectively. This is to say, the inner workings of these entities may be as shown in FIG. 14 and independently, the surrounding network topology may be that of FIG. 14.

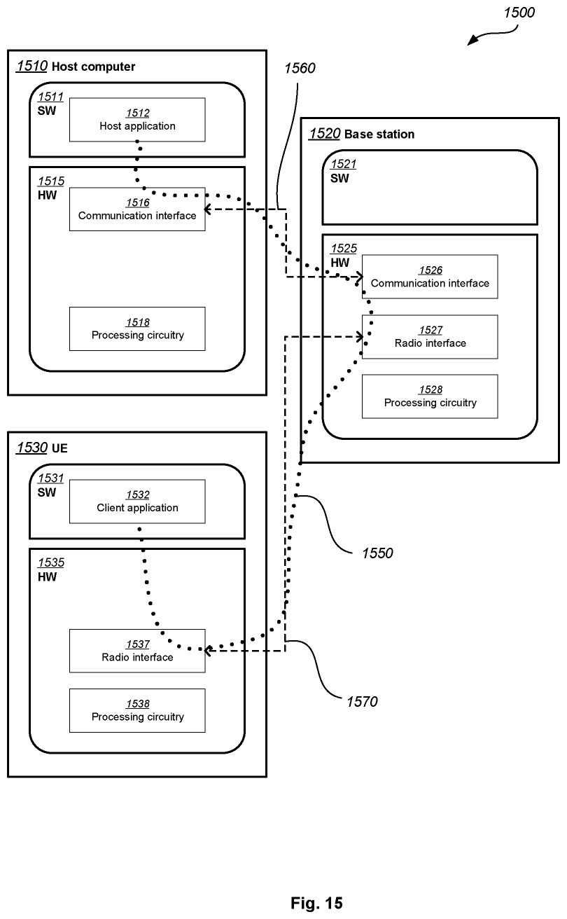

In FIG. 15, the OTT connection 1550 has been drawn abstractly to illustrate the communication between the host computer 1510 and the UE 1530 via the base station 1520, without explicit reference to any intermediary devices and the precise routing of messages via these devices. Network infrastructure may determine the routing, which it may be configured to hide from the UE 1530 or from the service provider operating the host computer 1510, or both. While the OTT connection 1550 is active, the network infrastructure may further take decisions by which it dynamically changes the routing (e.g., on the basis of load balancing consideration or reconfiguration of the network).

Wireless connection 1570 between the UE 1530 and the base station 1520 is in accordance with the teachings of the embodiments described throughout this disclosure. One or more of the various embodiments improve the performance of OTT services provided to the UE 1530 using the OTT connection 1550, in which the wireless connection 1570 forms the last segment. More precisely, the teachings of these embodiments may improve the data rate and power efficiency, and thereby provide benefits such as reduced user waiting time and reduced power consumption.

A measurement procedure may be provided for the purpose of monitoring data rate, latency and other factors on which the one or more embodiments improve. There may further be an optional network functionality for reconfiguring the OTT connection 1550 between the host computer 1510 and the UE 1530, in response to variations in the measurement results. The measurement procedure and/or the network functionality for reconfiguring the OTT connection 1550 may be implemented in software 1511 and hardware 1515 of the host computer 1510 or in software 1531 and hardware 1535 of the UE 1530, or both. In embodiments, sensors (not shown) may be deployed in or in association with communication devices through which the OTT connection 1550 passes; the sensors may participate in the measurement procedure by supplying values of the monitored quantities exemplified above, or supplying values of other physical quantities from which the software 1511, 1531 may compute or estimate the monitored quantities. The reconfiguring of the OTT connection 1550 may include message format, retransmission settings, preferred routing etc.; the reconfiguring need not affect the base station 1520, and it may be unknown or imperceptible to the base station 1520. Such procedures and functionalities may be known and practiced in the art. In certain embodiments, measurements may involve proprietary UE signaling facilitating the host computer 1510's measurements of throughput, propagation times, latency and the like. The measurements may be implemented in that the software 1511 and 1531 causes messages to be transmitted, in particular empty or ‘dummy’ messages, using the OTT connection 1550 while it monitors propagation times, errors etc.

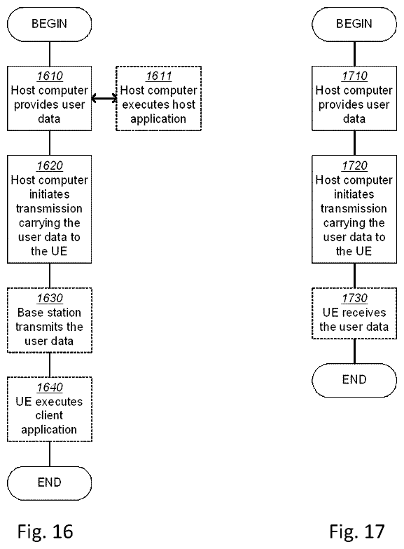

FIG. 16 is a flowchart illustrating a method implemented in a communication system, in accordance with an embodiment. The communication system includes a host computer, a base station and a UE which may be those described with reference to FIG. 14 and FIG. 15. For simplicity of the present disclosure, only drawing references to FIG. 16 will be included in this section. In step 1610, the host computer provides user data. In substep 1611 (which may be optional) of step 1610, the host computer provides the user data by executing a host application. In step 1620, the host computer initiates a transmission carrying the user data to the UE. In step 1630 (which may be optional), the base station transmits to the UE the user data which was carried in the transmission that the host computer initiated, in accordance with the teachings of the embodiments described throughout this disclosure. In step 1640 (which may also be optional), the UE executes a client application associated with the host application executed by the host computer.

FIG. 17 is a flowchart illustrating a method implemented in a communication system, in accordance with an embodiment. The communication system includes a host computer, a base station and a UE which may be those described with reference to FIG. 14 and FIG. 15. For simplicity of the present disclosure, only drawing references to FIG. 17 will be included in this section. In step 1710 of the method, the host computer provides user data. In an optional substep (not shown) the host computer provides the user data by executing a host application. In step 1720, the host computer initiates a transmission carrying the user data to the UE. The transmission may pass via the base station, in accordance with the teachings of the embodiments described throughout this disclosure. In step 1730 (which may be optional), the UE receives the user data carried in the transmission.

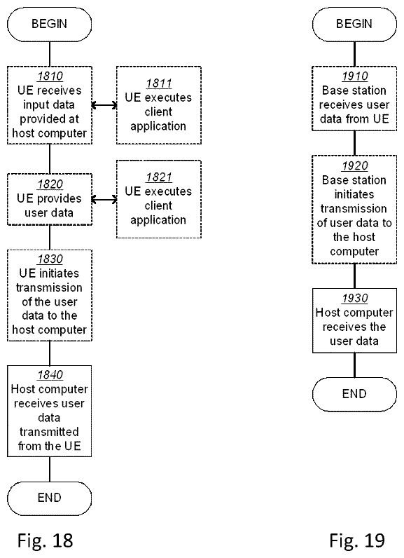

FIG. 18 is a flowchart illustrating a method implemented in a communication system, in accordance with an embodiment. The communication system includes a host computer, a base station and a UE which may be those described with reference to FIG. 14 and FIG. 15. For simplicity of the present disclosure, only drawing references to FIG. 18 will be included in this section. In step 1810 (which may be optional), the UE receives input data provided by the host computer. Additionally or alternatively, in step 1820, the UE provides user data. In substep 1821 (which may be optional) of step 1820, the UE provides the user data by executing a client application. In substep 1811 (which may be optional) of step 1810, the UE executes a client application which provides the user data in reaction to the received input data provided by the host computer. In providing the user data, the executed client application may further consider user input received from the user. Regardless of the specific manner in which the user data was provided, the UE initiates, in substep 1830 (which may be optional), transmission of the user data to the host computer. In step 1840 of the method, the host computer receives the user data transmitted from the UE, in accordance with the teachings of the embodiments described throughout this disclosure.

FIG. 19 is a flowchart illustrating a method implemented in a communication system, in accordance with an embodiment. The communication system includes a host computer, a base station and a UE which may be those described with reference to FIG. 14 and FIG. 15. For simplicity of the present disclosure, only drawing references to FIG. 19 will be included in this section. In step 1910 (which may be optional), in accordance with the teachings of the embodiments described throughout this disclosure, the base station receives user data from the UE. In step 1920 (which may be optional), the base station initiates transmission of the received user data to the host computer. In step 1930 (which may be optional), the host computer receives the user data carried in the transmission initiated by the base station.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

The present disclosure further provides the following embodiments.

The present disclosure is described in the context of NR sidelink (SL) communications. However, most of the embodiments are in general applicable to any kind of direct communications between UEs involving device-to-device (D2D) communications such as LTE SL. Embodiments are described from a TX UE and RX UE point of view. Further, it is assumed that a SL UE and its serving gNB (if the UE is in NW coverage) operates with the same radio access technology (RAT) e.g., NR, LTE, and so on. However, all the embodiments apply without loss of meaning to any combination of RATs between the SL UE and its serving gNB.

In the below embodiments, it is assumed that the Tx UE and the Rx UE(s) are SL CA capable if not otherwise declared.

A SL UE is configured with SL CA towards a peer UE, means that the UE is configured with multiple SL carriers for its SL transmissions or receptions. So the UE can aggregate these SL carriers together for its SL transmissions or receptions. The UE would be able to perform transmissions or receptions according to at least one of the following modes:
The UE may only use one of the SL carriers to perform SL transmission or reception.
The UE may use multiple SL carriers of the configured SL carriers simultaneously to perform SL transmission or reception. A transmission or reception on a SL carrier may be fully or partially overlapping in time domain with another transmission or reception on another SL carrier.

The UE maintains at least one PC5-RRC connection for all configured SL carriers. Each PC5 connection is established on one of the carriers. A term “syncFreqList” is used to stand for a list of frequencies configured to a UE that the UE can use to transmit SL sync info (e.g., SL SS/PBCH). The embodiments are not limited by the term. Any similar term is interchangeably applicable.

In addition, the following embodiments are applicable to SL transmission with any cast type including unicast, groupcast and broadcast unless otherwise stated.

In the first embodiment, for a UE configured with SL CA and transmitting to one or multiple destinations represented by e.g. L2 DST ID, it transmits SL synchronization info (e.g. SLSS and SL MIB) to each destination on at least one carrier frequency (i.e. not necessarily on multiple carrier frequencies to the destination) which is used for SL transmission to the destination even if the UE is not (pre)configured with the list of candidate synchronisation carrier frequencies or the list is (pre)configured but does not include any frequency used by the UE for its SL transmission (to the destination).

The UE may only transmit SL synchronization info on a frequency towards a destination when e.g. condition2 as described in section 2.1.2 is satisfied for that frequency. If no such frequency exists for a destination, the UE may not transmit SL synchronization info towards the destination.

In the second embodiment, the UE may prioritize transmitting SL synchronization info on the frequency which is shared by more destinations. For instance, suppose the UE transmits on f1, f2 and f3 to destination1, transmits on f2, f3 and f4 to destination2, and transmits on f3, f4 and f5 to destination4, the UE may select to transmit SL synchronization info (only) on f3 as it is shared by all the 3 destinations that it transmits to. In this case, it is beneficial for the UE to reduce overhead caused by transmission of SL sync info.

In the third embodiment, it may be (pre)configured that on how many carrier frequencies (e.g. (at most or at least) m carrier frequencies) the SL synchronization info shall be transmitted towards a destination. The configuration may be common for all destinations, or different for different destinations, or different for different destination types where the destination type may be identified based on e.g., cast type and/or service type associated with the destination, etc. The configuration may also be configured in a carrier band dependent way, e.g. the SL synchronization info is transmitted on more frequencies if the frequencies are in high frequency band (e.g. FR2) and vice versa. Based on the configuration, the UE selects the carrier frequencies in which the SL synchronization info shall be transmitted towards a destination, for instance, suppose that at most m carrier frequencies the SL synchronization info shall be transmitted towards a destination, and the UE could transmit SL synchronization info on n carrier frequencies (e.g. according to condition 2 in section 2.1.2), the UE transmits SL synchronization info in x carrier frequencies out of the n carrier frequencies where x is a number in the range between 1 and min(m,n). in another example, if the configuration is on at least m carrier frequencies the SL synchronization info shall be transmitted towards a destination, the UE transmits SL synchronization info in y carrier frequencies out of the n carrier frequencies where y is a number in the range between min(m,n) and n.

In the fourth embodiment, condition 1 described in section 2.1.2 is checked per destination. More specifically, for a frequency used for sidelink communication towards a destination, condition 1 is regarding as met if:
List of candidate synchronisation carrier frequencies are not (pre)configured for the destination.

### Or

The list is (pre)configured, but it does not include any frequency selected by the UE for its sidelink transmission towards the destination, or the concerned frequency is selected as the synchronisation carrier frequency

### Or

The list is (pre)configured and includes the concerned frequency, and for the destination, the UE has selected a frequency other than the concerned frequency as the synchronisation carrier frequency, and the UE is able to transmit SLSS/PSBCH on the concerned frequency.

For condition 2, the gNB may configure whether synchronization info shall be transmitted separately for each destination (type) to the UE. More specifically, for a frequency used for sidelink communication towards a destination (type), condition 2 is regarding as met if:
The UE is in RRC connected, and configured by the NW that synchronization information shall be transmitted towards the destination (type).

### Or

The UE is in coverage, and the measured Uu RSRP is lower than a configured threshold where the threshold may be per destination (type) configured.

### Or

The UE is out of coverage, and selects GNSS as the synchronization reference source.

### Or

The UE is out of coverage and not directly synchronized to GNSS, and has no selected synchronization reference (SyncRef) UE or the measured SL-RSRP to the selected SyncRef UE is below a preconfigured threshold where the threshold may be destination (type) dependent.

In this case, the UE shall transmit SLSS/PSBCH on the concerned frequency towards the destination if condition 1 is met for the destination and condition 2 is met for the destination (type).

In the fifth embodiment, for unicast, the peer UE may inform some assistance info to the UE, where the info may comprise any one or more of the following:
List of carrier frequencies on which the peer UE will/can or prefer to monitor synchronization info from the UE.
The synchronization reference source that the peer UE selects, represented by e.g., SLSSID.

Based on the assistance info, the UE may do the following:
Do not transmit SLSS/PSBCH on any frequency towards the peer UE if e.g. it uses the same synchronization reference source as the peer UE, even if the conditions for transmitting SLSS/PSBCH are met. Optionally the gNB may explicitly configure (or hardcoded in spec) that for unicast the UE could select to not transmit SLSS/PSBCH if it can determine that the same synchronization reference source is used by the peer UE, regardless of whether the conditions for transmitting SLSS/PSBCH are met.
Transmit SLSS/PSBCH towards the peer UE on specific frequencies, wherein SLSS/PSBCH can be transmitted by the UE and received by the peer UE according to configuration at its own side and the received assistance info.
If the UE is RRC connected, the UE may inform the assistance info to its serving gNB, and the serving gNB determines whether SLSS/PSBCH needs to be transmitted towards the peer UE, and if needed, on which frequencies to transmit, and informs the decision to the UE. During the determination procedure, the serving gNB of the UE may also communicate with the gNB of the peer UE.

Alternatively, the assistance info may be directly signaled to the gNB of the peer UE by the peer UE, the peer UE's gNB may determine one of the following for the UE pair
whether SLSS/PSBCH needs to be transmitted towards the peer UE by the UE,
if SLSS/PSBCH needs to be transmitted towards the peer UE by the UE, on which frequencies the transmission can be performed

The gNB of the peer UE may then inform the decision to the gNB of the UE, or inform the decision to the peer UE which may further inform it to the UE over sidelink.

In the sixth embodiment, it may be (pre)configured that SLSS/PSBCH is always (and only) transmitted on specific (pre)configured frequencies, even the UE is not transmitting any traffic on the frequencies, e.g. the frequency where Rel. 16 SL communication is performed and the transmitted SLSS/PSBCH can be received by all NR UEs capable of SL regardless of its Release. Alternatively, for each Release different specific frequencies may be (pre)configured for transmitting SLSS/PSBCH. In one example, discovery and/or unicast link establishment can only be transmitted on frequencies where SLSS/PSBCH is transmitted, in another example, each service may be (pre)configured with specific frequencies where SLSS/PSBCH is transmitted, and a UE transmitting or interested in receiving a service shall be capable of transmitting or receiving SLSS/PSBCH on the associated specific frequencies.

In the seventh embodiment, for any of the above embodiments, any signaling between UE and the gNB includes at least one of the below:
Common and/or dedicated RRC signaling
MAC CE
Paging message
Control PDU of a protocol layer (e.g., SDAP, PDCP, RLC, or an adaptation layer in case of SL relay)
L1 signaling on channels such as PRACH, PUCCH, PDCCH

Any signaling between UEs include at least one of the following signaling alternatives:
RRC signaling (i.e., PC5-RRC)
PC5-S signaling (i.e., discovery, unicast link establishment request/response)
MAC CE
Control PDU of a protocol layer (e.g., SDAP, PDCP, RLC, or an adaptation layer in case of SL relay)
L1 signaling on channels such as PSSCH, PSCCH, PSFCH etc.

By implementing the mechanisms proposed in the present disclosure, it can be avoided that the UE unnecessarily transmit sidelink synchronization info on many frequencies, or transmits a service without transmitting sidelink synchronization info on any frequency on which the service is transmitted. Besides, sidelink synchronization info transmission in unicast case is optimized via inter-UE coordination. All these are important to enable a proper SL communication when CA is supported

1. A method in a terminal device configured with a plurality of carrier frequencies for sidelink communication with a plurality of peer terminal devices, comprising:
transmitting, to each of the plurality of peer terminal devices, sidelink synchronization information on at least one carrier frequency for sidelink communication with the peer terminal device.

2. The method of claim 1, wherein, for at least one of the plurality of peer terminal devices, a number of the at least one carrier frequency for sidelink communication with the peer terminal device is less than the number of all carrier frequencies for sidelink communication with the peer terminal device.

3. The method of claim 1, wherein the sidelink synchronization information is transmitted when:
the terminal device is not configured with a list of candidate synchronization carrier frequencies, or
the terminal device is configured with a list of candidate synchronization carrier frequencies and the list does not include any carrier frequency used for sidelink communication with the peer terminal device.

4. The method of claim 1, wherein, among the plurality of carrier frequencies, a carrier frequency used for sidelink communication with more peer terminal devices has a higher priority to be used for transmitting the sidelink synchronization information.

5. The method of claim 1, wherein, for at least one of the plurality of peer terminal devices, said transmitting, to each of the at least one peer terminal device, the sidelink synchronization information on at least one carrier frequency for sidelink communication with the peer terminal device comprises:
transmitting the sidelink synchronization information on a first number of, at least a second number of, or at most a third number of, carrier frequencies for sidelink communication with the peer terminal device.

6. The method of claim 5, wherein the first number, the second number, or the third number is configured by a network node, and/or is dependent on one or more of:
the peer terminal device,
a type of sidelink communication with the peer terminal device,
a service type associated with sidelink communication with the peer terminal device, or a frequency band of the first, second, or third number of carrier frequencies.

7. The method of claim 6, wherein the type of sidelink communication comprises broadcast, multicast, or unicast.

8. The method of claim 1, wherein, for each carrier frequency used for sidelink communication with each peer terminal device, the sidelink synchronization information is transmitted to the peer terminal device on the carrier frequency when:
the terminal device is not configured with a list of candidate synchronization carrier frequencies for the peer terminal device,
the terminal device is configured with a list of candidate synchronization carrier frequencies, but the list does not include any carrier frequency selected by the terminal device for sidelink communication with the peer terminal device, or the carrier frequency is selected as a synchronization carrier frequency, or
the terminal device is configured with a list of candidate synchronization carrier frequencies that includes the carrier frequency, and for the peer terminal device, the terminal device has selected another carrier frequency as a synchronization carrier frequency and the terminal device is capable of transmitting the sidelink synchronization information on the carrier frequency.

9. The method of claim 8, wherein, for each peer terminal device, the sidelink synchronization information is transmitted to the peer terminal device when:
the terminal device is in a Radio Resource Control, RRC, connected state and is configured by a network node to transmit the sidelink synchronization information to the peer terminal device,
the terminal device is in coverage and measured Uu Reference Signal Received Power, RSRP, is lower than a configured threshold for the peer terminal device,
the terminal device is out of coverage and selects a Global Navigation Satellite System, GNSS, as a synchronization reference source, or
the terminal device is out of coverage and not directly synchronized to the GNSS, and has no selected synchronization reference terminal device or has a selected synchronization reference terminal device but measured sidelink RSRP to the selected synchronization reference terminal device is lower than a preconfigured threshold for the peer terminal device.

10. A method in a terminal device configured with one or more carrier frequencies for unicast sidelink communication with a peer terminal device, comprising:
determining whether and/or on which one or more carrier frequencies to transmit sidelink synchronization information to the peer terminal device based on assistance information; or
receiving information on a determination, made based on the assistance information, about whether and/or on which one or more carrier frequencies to transmit the sidelink synchronization information to the peer terminal device,
wherein the assistance information comprises one or more of:
a list of carrier frequencies on which the peer terminal device is to monitor, is capable of monitoring, or prefers to monitor, sidelink synchronization information from the terminal device, or
a synchronization reference resource selected by the peer terminal device.

11. The method of claim 10, wherein
said determining comprises: determining not to transmit the sidelink synchronization information to the peer terminal device when the terminal device uses the same synchronization reference resource as selected by the peer terminal device, or
the determination not to transmit the sidelink synchronization information to the peer terminal device is made when the terminal device uses the same synchronization reference resource as selected by the peer terminal device.

12. The method of claim 10, further comprising, prior to said determining:
receiving the assistance information from the peer terminal device.

13. The method of claim 10, further comprising, prior to said receiving:
receiving the assistance information from the peer terminal device; and
transmitting the assistance information to a network node,
wherein the information on the determination is received from the network node.

14. The method of claim 10, wherein the information on the determination is received from the peer terminal device.

15. The method of claim 10, wherein
the information on the determination is received from the peer terminal device using:
Radio Resource Control, RRC, signaling,
PC5 Signaling, PC5-S,
Medium Access Control, MAC, Control Element, CE,
control Protocol Data Unit, PDU, of a protocol layer, or
Layer 1, L1, signaling, or
the information on the determination is received from the network node using:
RRC signaling,
MAC CE,
paging message,
control PDU of a protocol layer, or
L1 signaling.

16. A method in a terminal device, comprising:
transmitting sidelink synchronization information on one or more carrier frequencies when none of the one or more carrier frequencies is used for transmission of any sidelink traffic.

17. The method of claim 16, wherein the one or more carrier frequencies comprise one or more carrier frequencies configured for legacy sidelink communication.

18. The method of claim 16, wherein the one or more carrier frequencies comprise carrier frequencies specific to different releases or services.

19-51. (canceled)
